(19) United States
(12) Patent Application Publication
(10) Pub. No.: US 2024/0116162 A1
(43) Pub. Date: Apr. 11, 2024

(54) Multi-Stroke Powered Safety Hammer System With Powered Staple Tool

(71) Applicant: Donald W. Carlson, Scottsdale, AZ (US)

(72) Inventors: Donald W. Carlson, Scottsdale, AZ (US); Donald Perron, North Smithfield, RI (US); Prudencio S. Canlas, North Kingstown, RI (US)

(73) Assignee: Donald W. Carlson, Scottsdale, AZ (US)

(21) Appl. No.: 18/539,026

(22) Filed: Dec. 13, 2023

Related U.S. Application Data
(63) Continuation-in-part of application No. 17/383,096, filed on Jul. 22, 2021.
Application No. 17/383,096 is a continuation of application No. 16/745,926, filed on Jan. 17, 2020, now abandoned.
(60) Provisional application No. 62/793,811, filed on Jan. 17, 2019.

(51) Int. Cl. B25F 3/00; B25C 1/00; B25C 1/04; B25C 7/00; B25D 9/04; B25D 17/02

(52) U.S. Cl. CPC B25F 3/00; B25C 1/008; B25C 1/047; B25C 7/00; B25D 9/04; B25D 17/02; B25C 11/00

(57) ABSTRACT

A powered tool includes a body, a cylinder, an impact piston reciprocating within the cylinder, and a mount to secure an attachment. The attachment includes a shank and a head sleeve fit over the shank and extending beyond its front end. The head sleeve includes a nozzle at its front end having a slot terminating at a muzzle. An internal hold in the head sleeve is in open communication with the slot. The front end of the shank is disposed within the internal hold and reciprocates therein. A rod is carried within the head sleeve for reciprocal movement in response to reciprocation of the shank with respect to the head sleeve. The rod includes a tongue extending from the internal hold into the slot of the nozzle. The tongue terminates inside the slot for reciprocal movement within the slot in response to reciprocal movement of the shank.

### CROSS-REFERENCE TO RELATED APPLICATIONS

This application is a continuation-in-part of and claims the benefit of U.S. patent application Ser. No. 17/383,096, filed Jul. 22, 2021, which is a continuation of and claims the benefit of U.S. patent application Ser. No. 16/745,926, filed Jan. 17, 2020, which claims the benefit of U.S. Provisional Application No. 62/793,811, filed Jan. 17, 2019, all of which are hereby incorporated by reference in their entireties.

### FIELD

The present specification relates generally to tools, and more particularly to hammering, nailing, stapling, pounding, and other powered impact tools used for material processing.

### BACKGROUND

The advent of powered tools ushered productivity and efficiency into the construction and similar product processing industries. Workers using powered tools such as nail and staple guns, drills, saws, and screwdrivers became able to work faster, more efficiently, and with greater accuracy than their counterparts equipped with manually-operated tools.

Many of these tools required fasteners to be linked together, or collated. Powered nail and staple guns using dedicated collated fasteners are limited in their ability to drive individual fasteners, however. These tools cannot handle the myriad of hand-held and hand-driven nails, staples, and similar singleton fasteners which must instead be driven by manual hammers.

Currently-available tools cannot always be efficiently used in all situations. Frequently, the design of houses and similar structures and assemblies dictates the need to properly, precisely, and effectively install fasteners where there is limited, confined, or remote access. By the nature of their configuration, both powered nail and staple guns, and also manual hammers, present substantial difficulties of use in such locations. Manual hammers, for instance, can be difficult to swing in awkward spaces, like upside down under a truss.

Manual tools also expose their users to musculoskeletal injuries. The constant and repetitive gripping, swinging, and pounding of a hammer, for instance, presents a risk of carpal tunnel syndrome, tendonitis, carpenter's elbow, rotator cuff damage, and similar ailments. And, of course, fingers and thumbs are always being smashed and broken.

Moreover, manual tools are not necessarily sufficiently precise to guarantee consistency. Building and national standardized codes set standards for driving fasteners, such as the manner, depth, and other characteristics. Materials and fastener manufacturers additionally recommend or even warrant similar characteristics, while making no claim or promise regarding fasteners driven in another way. Manual tools used in the best of circumstances cannot reliably drive nails, staples, pins, and other fasteners consistently to ensure that codes, standards, and recommendations are always met. Manual tools used in more real-world circumstances—such as by a worker with arthritis, who has been holding the tool for several hours already, who might be hammering upside, or is using the tool in a confined space—are even less reliable.

For all of these reasons, an improved powered tool is needed which provides proper, precise, reliable, consistent, and safe driving of single fasteners.

### SUMMARY

The multi-stroke powered safety hammer system described herein is a safer, healthier alternative to manual hammers, reducing workers' exposure to musculoskeletal injuries. It allows workers to drive a wide range of hand-held nails, staples, spikes, and other fasteners faster, more effectively, and efficiently than manual hammers. Further, workers can easily change the processing mode of the hammer system between one of many various powered fastener applicators, fastener extractors, and punches, as well as processing tools such as chisels, scrapers, chippers, and similar tools for materials preparation, deconstruction, salvage, and demolition. Workers can also apply specialty pounding and shaping attachments such as hard, soft, flat, or curved hammering heads.

A multi-stroke powered safety hammer including a cylinder having an end, the cylinder mounted to and extending outwardly from a body to the end, and an impact piston disposed within the cylinder for axial reciprocating movement, the impact having including a striking surface at a front end thereof. The hammer further includes a mount connected releasably over the end of the cylinder and is configured to receive and releasably secure a base of a tool for reciprocating movement, the base including an end having an impact surface. The end of the cylinder is configured to receive the end of the base for reciprocating movement in confronting relation of the impact surface to the striking surface when the base is received and releasably secured by the mount for reciprocating movement.

An attachment for a powered tool includes a shank having a front end, a rear end, and a length extending therebetween. A head sleeve is fit over the shank proximate the front end thereof and extends beyond the front end. The head sleeve includes a front end, an opposed rear end, and a nozzle at the front end of the head sleeve having a slot terminating at a muzzle. An internal hold is in the head sleeve, in open communication with the slot in the nozzle. The front end of the shank is disposed within the internal hold of the head sleeve and reciprocates therein along an axial direction. A rod is carried within the head sleeve for reciprocal movement between advanced and retracted positions in response to reciprocation of the front end of the shank with respect to the head sleeve, wherein the rod includes a block carried in the internal hold and a tongue extending from the internal hold into the slot of the nozzle. The tongue terminates inside the slot for reciprocal movement within the slot in response to reciprocal movement of the shank with respect to the head sleeve.

An attachment for a powered tool includes a shank and a blade secured to the shank. The blade is configured to remove staples from a workpiece. The blade includes an inner edge and an opposed outer edge, wherein the inner edge is concave and the outer edge is convex. The shank includes an engagement portion opposite the blade configured to engage with the powered tool.

A powered tool includes a body housing a cylinder extending outwardly from the body to an end, an impact piston carried within the cylinder for axial reciprocating movement, the impact piston including a striking surface at a front end thereof, and a mount connected over the end of the cylinder, the mount configured to receive and releasably secure an attachment. The attachment includes a shank having a front end and an opposed rear end configured for receipt in the mount. A head sleeve is fit over the shank proximate the front end thereof and extending beyond the front end. The head sleeve includes a front end and a nozzle at the front end of the head sleeve having a slot terminating at a muzzle. An internal hold is in the head sleeve and in open communication with the slot in the nozzle. The front end of the shank is disposed within the internal hold of the head sleeve and reciprocates therein along an axial direction. A rod is carried within the head sleeve for reciprocal movement between advanced and retracted positions in response to reciprocation of the front end of the shank with respect to the head sleeve. The rod includes a tongue extending from the internal hold into the slot of the nozzle, and the tongue terminates inside the slot for reciprocal movement within the slot in response to reciprocal movement of the shank with respect to the head sleeve.

The above provides the reader with a very brief summary of some embodiments described below. Simplifications and omissions are made, and the summary is not intended to limit or define in any way the disclosure. Rather, this brief summary merely introduces the reader to some aspects of some embodiments in preparation for the detailed description that follows.

### BRIEF DESCRIPTION OF THE DRAWINGS

Referring to the drawings:

FIGS. 1A, 1B, and 1C are top, bottom, and exploded perspective views, respectively, of a multi-stroke powered safety hammer system including a hammer, a quick-coupling mount, and a nosepiece attachment;

FIGS. 1D and 1E are section views taken along the line 1-1 in FIG. 1A, showing a piston within the hammer in advanced and retracted positions, respectively;

FIG. 1F is a section view taken along the line 1-1 in FIG. 1A showing the piston moving toward the advanced position, impacting a driver of the nosepiece attachment;

FIG. 1G is a section view taken along the line 1-1 in FIG. 1A showing the piston in the advanced position, and the driver of the nosepiece attachment moving forward;

FIG. 1H is a section view taken along the line 1-1 in FIG. 1A showing the quick-coupling mount in an unlocked condition and the nosepiece attachment being removed therefrom;

FIG. 2A is a perspective view of the nosepiece of FIG. 1A;

FIGS. 2B and 2C are section views taken along the line 2-2 in FIG. 2A, showing the nosepiece in extended and retracted positions, respectively;

FIG. 3A is a perspective view of a nosepiece attachment for use with the hammer;

FIGS. 3B and 3C are section views taken along the line 3-3 in FIG. 3A, showing the nosepiece in extended and retracted positions, respectively;

FIG. 4A is a perspective view of a nosepiece attachment for use with the hammer;

FIGS. 4B and 4C are section views taken along the line 4-4 in FIG. 4A, showing the nosepiece in extended and retracted positions, respectively;

FIG. 5 is a perspective view of a processing tool for use with the hammer;

FIG. 6 is a perspective view of a processing tool for use with the hammer;

FIG. 7 is a perspective view of a fencing stapler remover for use with the hammer;

FIG. 8A is a perspective view of a de-nailer attachment for use with the hammer;

FIG. 8B is a section view taken of the de-nailer along the line 8-8 in FIG. 8A;

FIG. 9A is a perspective view of a de-stapler attachment for use with the hammer;

FIG. 9B is a section view taken of the de-stapler along the line 9-9 in FIG. 9A;

FIG. 10 is a perspective view of a conical processing tool for use with the hammer;

FIG. 11 is a perspective view of a wide scraping attachment for use with the hammer;

FIG. 12 is a perspective view of a chiseling tool for use with the hammer;

FIG. 13 is a perspective view of a chipping tool for use with the hammer;

FIG. 14A is a perspective view of a soft hammer head and shank for use with the hammer;

FIG. 14B is a section view taken of the soft hammer head and shank along the line 14-14 in FIG. 14A;

FIG. 15A is a perspective view of a convex hammer head and shank for use with the hammer;

FIG. 15B is a section view taken of the convex hammer head and shank along the line 15-15 in FIG. 15A;

FIG. 16A is a perspective view of a flat hammer head and shank for use with the hammer;

FIG. 16B is a section view taken of the flat hammer head and shank along the line 16-16 in FIG. 16A;

FIG. 17 is a top perspective view of a powered staple tool;

FIG. 18 is a section view of the powered staple tool taken along the line 18-18 in FIG. 17;

FIG. 19 is a perspective section view of the powered staple tool taken along the line 18-18 in FIG. 17;

FIG. 20 is an enlarged perspective section view of the powered staple tool taken along the line 18-18 in FIG. 17;

FIGS. 21A and 21B are perspective section views of the powered staple tool taken along the line 21-21 in FIG. 17;

FIG. 22 is a perspective view of an attachment for the powered staple tool;

FIG. 23 is a section view taken along the line 23-23 in FIG. 22;

FIG. 24 is a side elevation view of an attachment for the powered staple tool; and

FIG. 25 is a section view taken along the line 25-25 in FIG. 24.

### DETAILED DESCRIPTION

Reference now is made to the drawings, in which the same reference characters are used throughout the different figures to designate the same elements. Briefly, the embodiments presented herein are preferred exemplary embodiments and are not intended to limit the scope, applicability, or configuration of all possible embodiments, but rather to provide an enabling description for all possible embodiments within the scope and spirit of the specification. Description of these preferred embodiments is generally made with the use of verbs such as “is” and “are” rather than “may,” “could,” “includes,” “comprises,” and the like, because the description is made with reference to the drawings presented. One having ordinary skill in the art will understand that changes may be made in the structure, arrangement, number, and function of elements and features without departing from the scope and spirit of the specification. Further, the description may omit certain information which is readily known to one having ordinary skill in the art to prevent crowding the description with detail which is not necessary for enablement. Indeed, the diction used herein is meant to be readable and informational rather than to delineate and limit the specification; therefore, the scope and spirit of the specification should not be limited by the following description and its language choices.

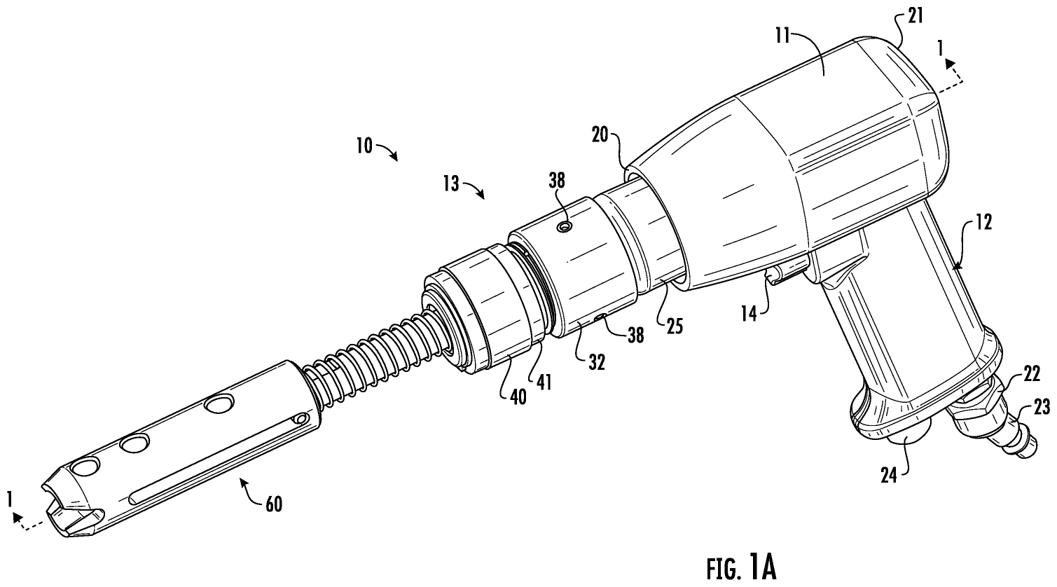

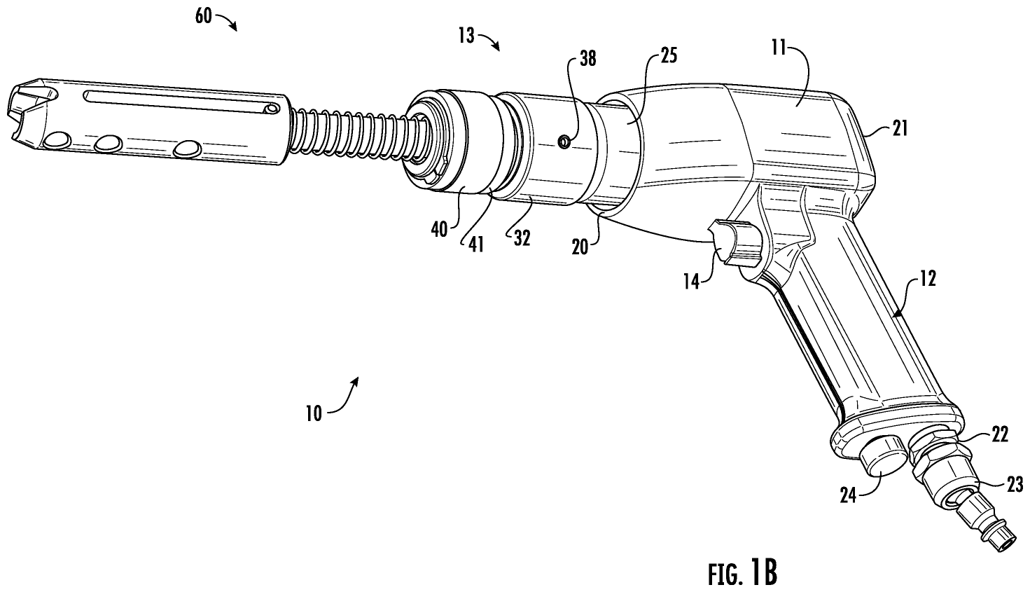

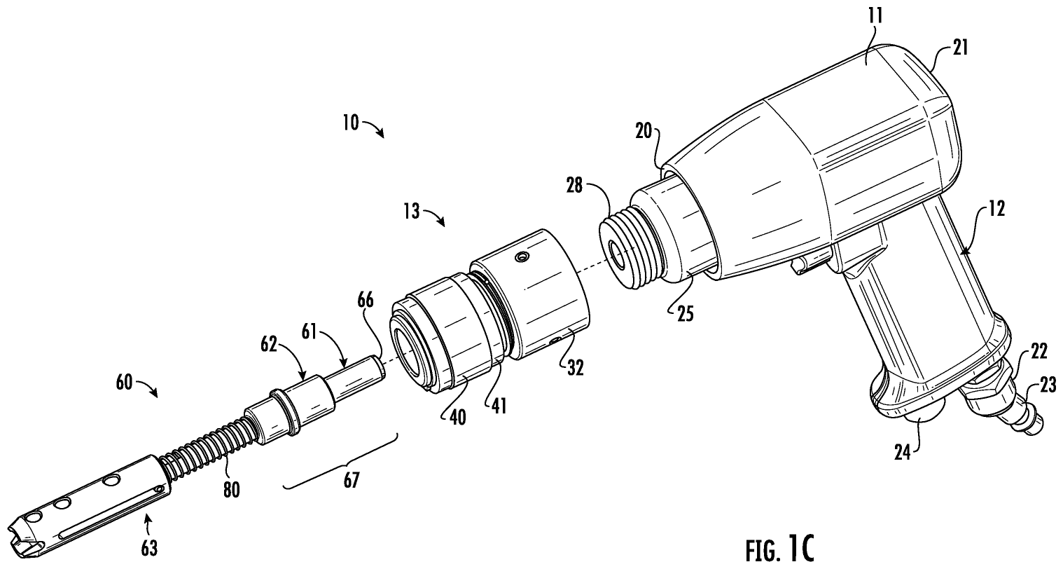

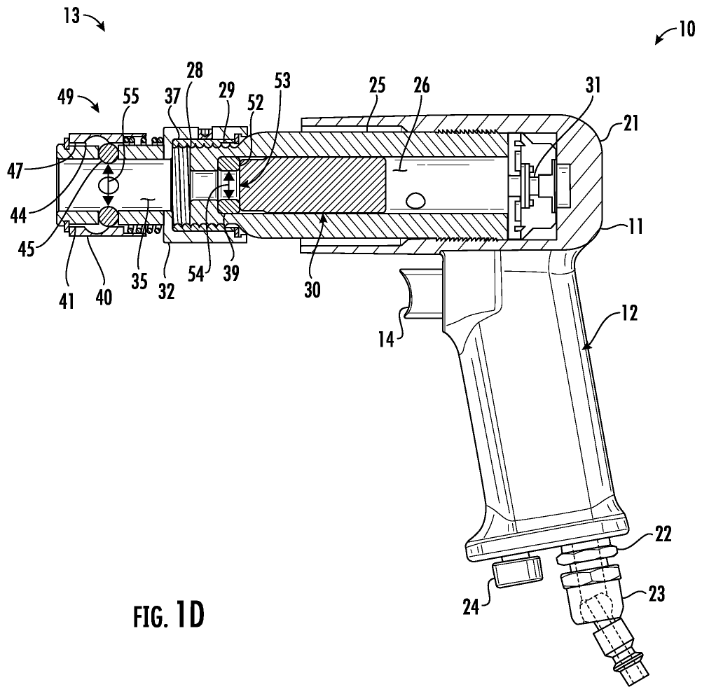

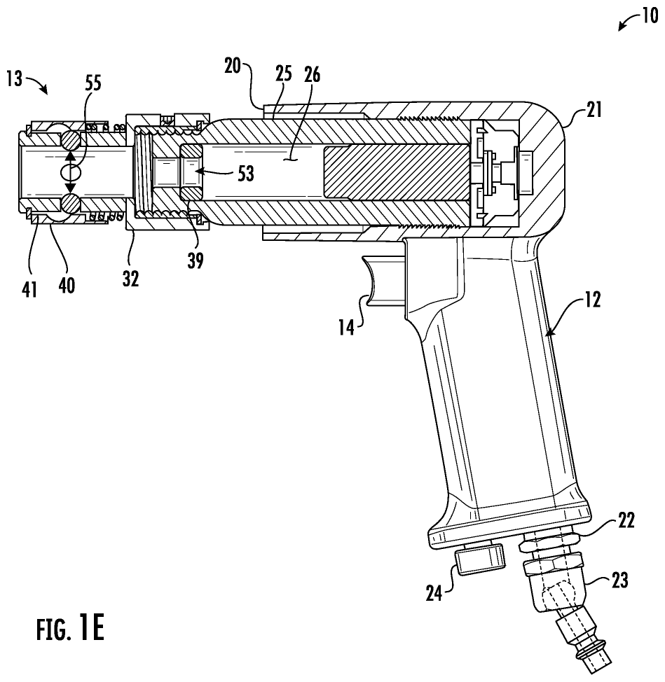

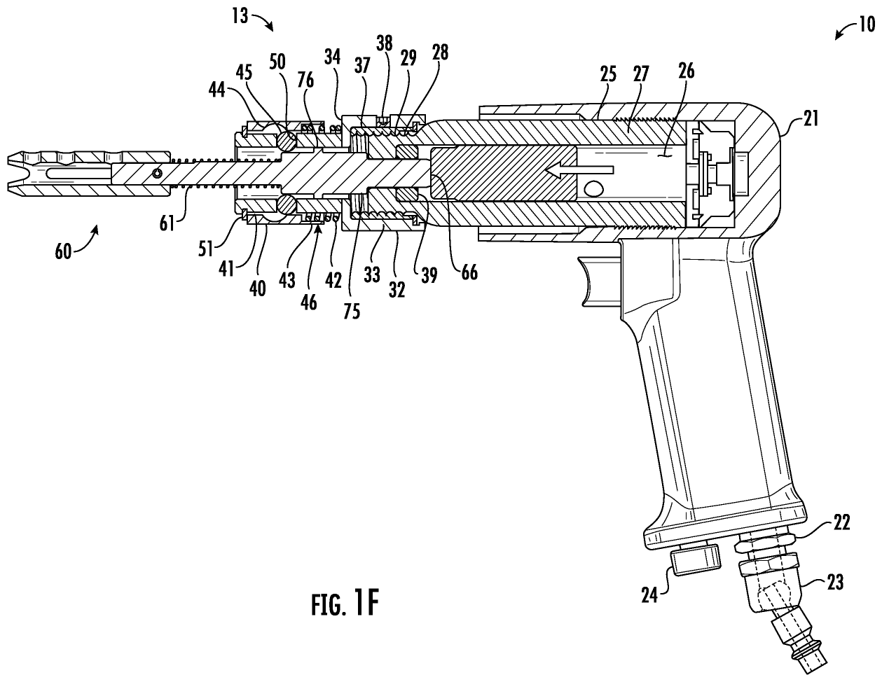

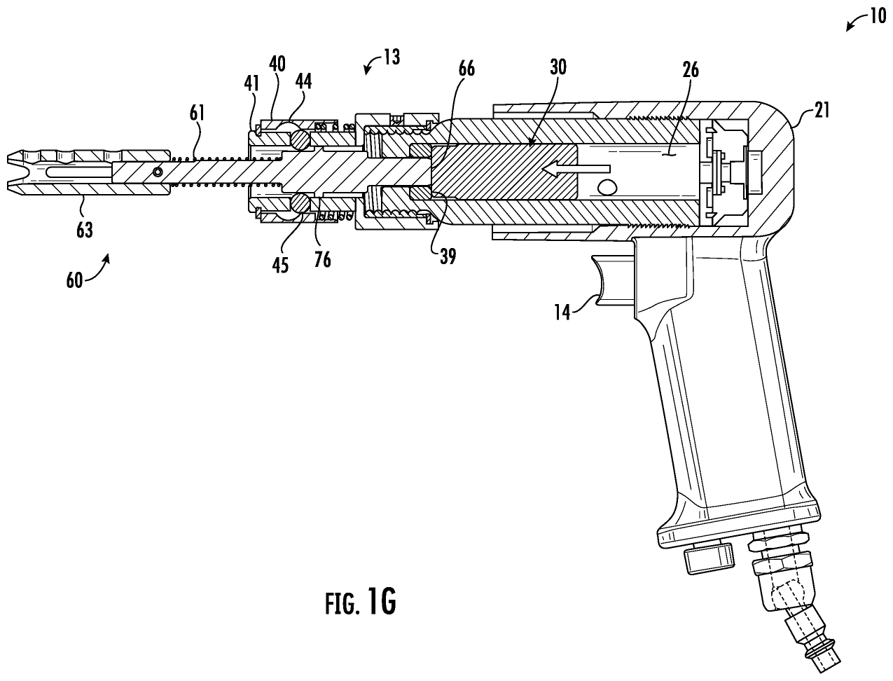

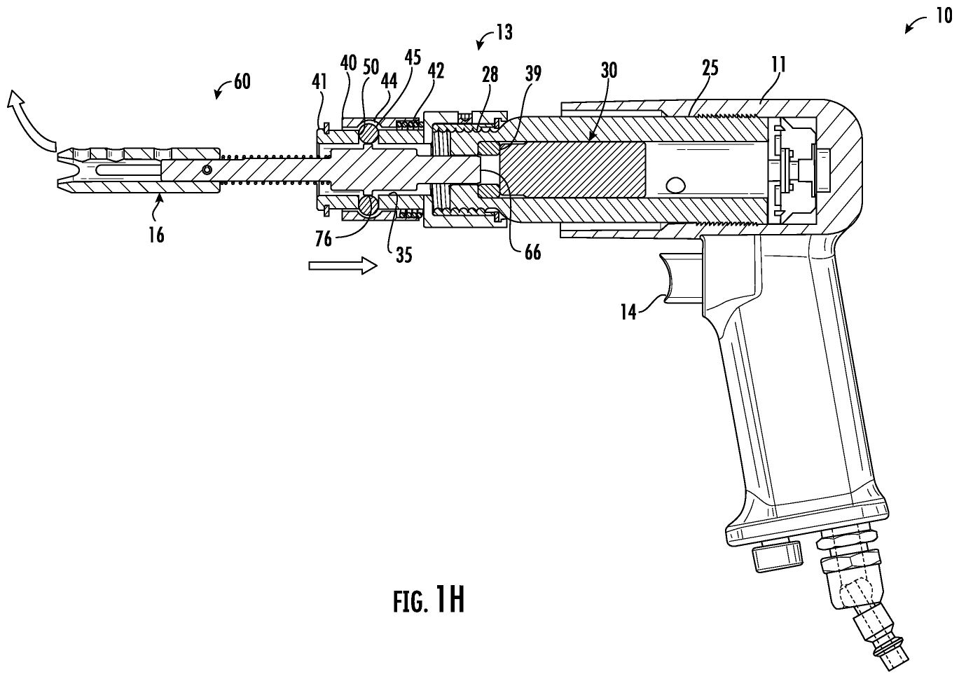

FIGS. 1A-1H illustrate a multi-stroke powered safety hammer 10 (hereinafter, the “hammer 10”) including a body 11, a handle 12 formed integrally and monolithically to the body 11, and a quick-connect coupling mount 13 (hereinafter, the “mount 13”). A variety of removable attachments 16, such as nail guides, nosepieces, fixed implements, processing tools, and the like, shown in the remaining drawings, are applicable to the mount 13 of the hammer 10 to convert the hammer 10 into a variety of special-purpose powered processing hammer tools. Each is an attachment 16, but each is given a unique name and reference character for clarity.

Indeed, in FIGS. 1A-1C and 1F-1H, the hammer 10 is fit with one such attachment 16, identified as a nosepiece 60, which is suitable for driving nails of approximately 3½ inches in length. Single nails, spikes, staples, and other fasteners are loaded into some of these nosepieces for driving by a cyclical, reciprocal, multi-stroke hammering action. Other of the attachments 16 are processing bits or fixed implements and are applied to the hammer 10 to work a surface, such as by chiseling along a surface, boring out a hole, or punching a nail through a piece of lumber. Pneumatic and mechanical parts within the body 11 operate to cycle a moveable piston through the body 11 and into the selected nosepiece fit onto the hammer. A trigger 14 activates operation of the hammer 10 in the worker's hand.

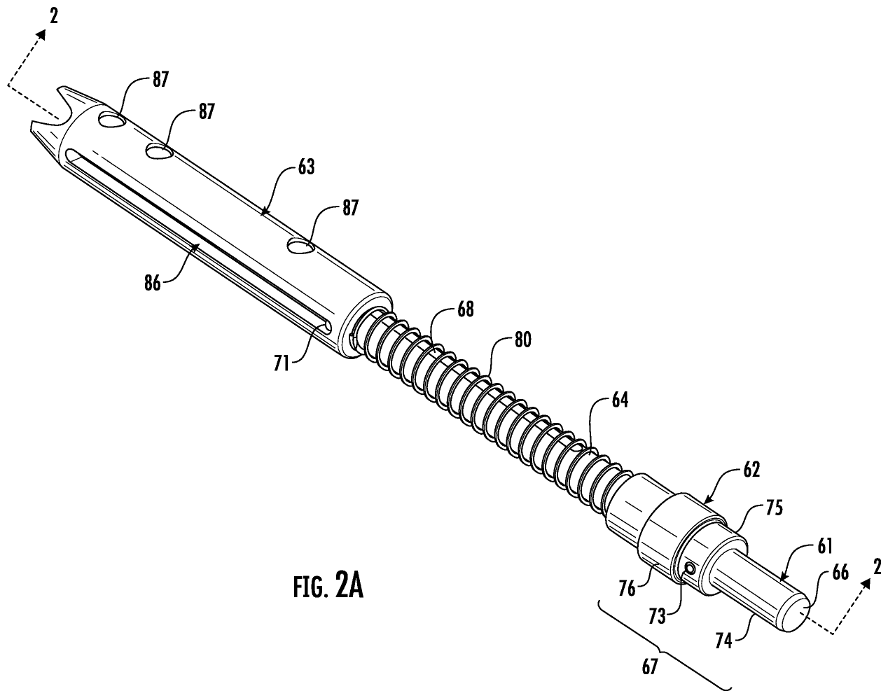

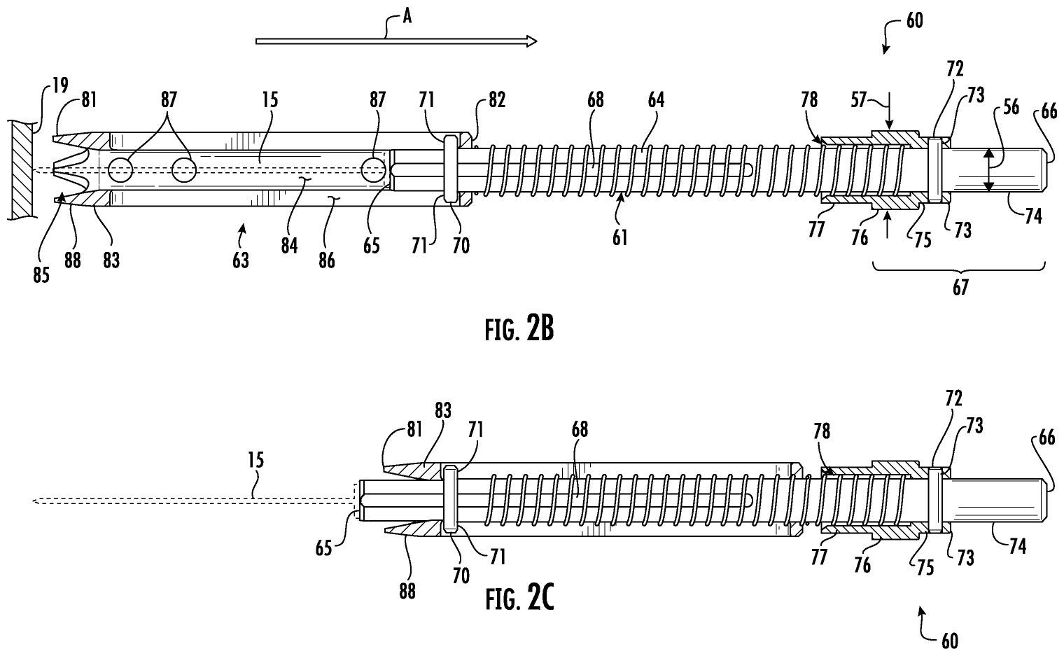

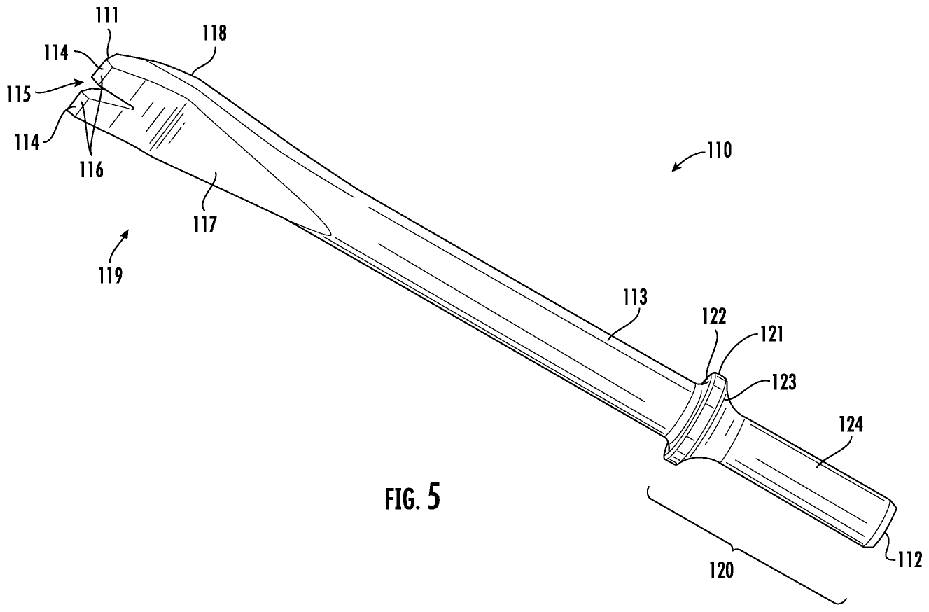

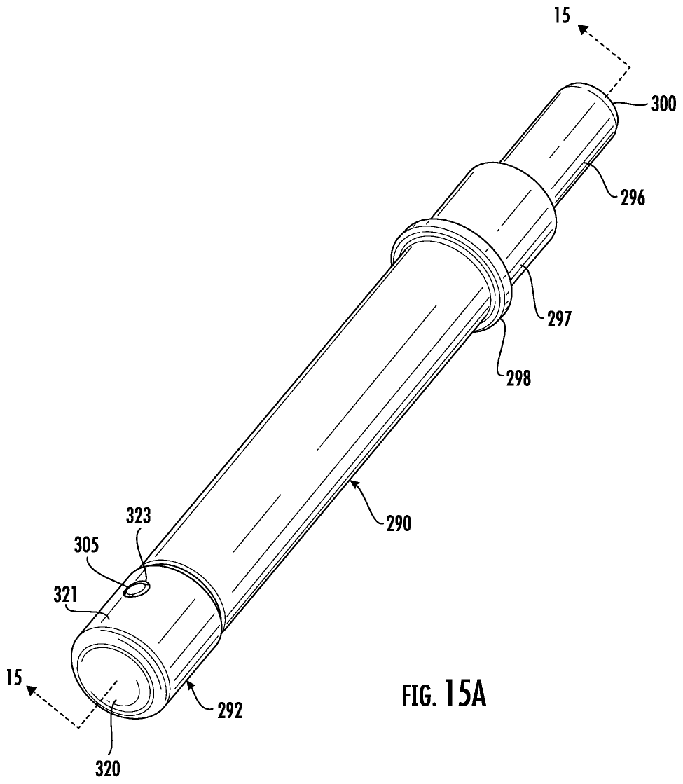

FIGS. 2A-16B illustrate some of the various attachments. Those of FIGS. 2A-4C are guides for holding and driving fasteners, while those of FIGS. 5-13 are processing tools, and FIGS. 14A-16B show various types of hammering heads for different applications. Each is described in detail below.

FIGS. 1A and 1B are top and bottom front perspective views of the hammer 10 with the nosepiece 60, FIG. 1C is an exploded view of the hammer 10 and nosepiece 60, and FIGS. 1D-1F are partial section views of the hammer 10 taken along the line 1-1 in FIG. 1A. The description of the hammer 10 is made herein with respect to the FIGS. 1A-1H. FIGS. 1F-1H are section views showing the nosepiece 60 applied to the hammer 10, but do not show all of the structural elements and features of the nosepiece 60 for simplicity. The body 11 of the hammer 10 is a large hollow housing, constructed from a molded sidewall of very hard, rigid, rugged, and durable material or combination of materials, such as high-density plastic or metal. The body 11 surrounds and protects the internal componentry of the hammer 10 and provides mounting locations for such componentry.

The body 11 extends from a front end 20 to an opposed rear end 21. A cylinder 25 is engaged within the body 11 and projects out of the front end 20. The rear of the cylinder 25 has outwardly-directed threads which threadably engage with internally-directed threads inside the body 11 to hold the cylinder 25 in place within the body 11. The cylinder 25 bounds and defines a cylindrical interior 26 of the hammer 10 in which a piston 30 reciprocates between an advanced position toward the front end 20 (as shown in FIG. 1D) and a retracted position toward the rear end 21 (as shown in FIG. 1E). The interior 26 is substantially enclosed; the body 11 encloses the rear end of the interior 26, the cylinder 25 encircles the interior 26, and the mount 13 is secured to the front of the cylinder 25. While the mount 13 is open, it is usually fit with an attachment 16 which encloses the front of the interior 26.

Below the body 11, and formed integrally and monolithically as part of the same sidewall forming the body 11, the handle 12 extends downward and provides a location at which a worker can grab and hold the hammer 10. The handle 12 is a slender extension of the body 11. It is, like the body 11 to which it is formed, constructed from a hard, rigid, rugged, and durable material or combination of materials, such as high-density plastic or metal. The handle 12 extends from a top to an opposed bottom. A slot through the body 11 is formed at the top, and the trigger 14 is disposed in this slot. The handle 12 is generally thin between the top and the bottom, and flares outwardly at the bottom. An end cap 22 is affixed to the bottom, where a pneumatic coupling 23 is located and available to receive a pneumatic hose. A pneumatic adjuster 24 is proximate the end cap 22 and adjustable to set the flow rater of gas through the end cap 22.

Preferably, and though not shown in these drawings, most of the length of the handle 12 is covered by an anti-shock cushioned grip. The grip is a sleeve fit over the handle 12 to provide the worker with cushion when operating the hammer 10 to reduce transmission of vibration and impact forces from the hammer 10 to the worker.

The trigger 14 is disposed in the slot in front of the handle 12 to be depressed by an index finger of the worker. Depression of the trigger 14 causes the hammer 10 to operate. When the trigger 14 is depressed, compressed gas, preferably supplied by a pneumatic hose connected to the pneumatic coupling 23 and extending from a compressor or other source, is routed into the componentry within the body 11. The compressed gas is passed into the interior 26 behind the piston 30 carried therein. The piston 30 is mounted for reciprocal movement within the cylinder 25. A port 31 at the back of the cylinder 25 communicates the supplied compressed gas behind the piston 30, and the piston 30 quickly moves forward as the interior 26 behind the piston 30 fills with gas. As the piston 30 moves forward, that gas is vented, and then a port at the front end of the cylinder 25 communicates supplied compressed gas in front of the piston 30. This causes the piston 30 to move quickly backward as the interior 26 in front of the piston 30 fills with gas. Gas is rapidly cycled between these two ports, causing the piston 30 to rapidly reciprocate between the advanced and retracted positions. The cylinder 25 has a larger bore than is typical of other pneumatic tools. Whereas conventional tools have a 0.750 inch bore, the bore of the cylinder 25 is preferably, but not necessarily, 0.814 inches. This larger bore provides greater energy per stroke length, resulting in more powerful and faster hammering. It should be understood that the bore dimension of 0.814 inches, though preferable, is by no means intended to be limiting to this disclosure, and the cylinder 25 may have other dimensions while remaining operable and suitable for the function of the hammer 10.

A bumper 39 is carried within the cylinder 25. The bumper 39 is disposed at the front of the cylinder 25, in front of the piston 30 and thus between the piston 30 and the cylinder 25. The bumper 39 is retained at the front of the piston 30 at all times while the piston 30 reciprocates. The bumper 39 includes an annular body 52 and a central bore 53 formed therein. The body 52 has an outer diameter that is equal to the inner diameter of the cylinder 25, such that the body 52 is snugly fit within the cylinder 25 at the front end thereof. The bore 53 is coaxial to and registered with the piston 30 and the hollow interior 35 of the mount 13. Indeed, the bumper 39 is actually disposed within the interior 35 because it is carried in the neck 28 of the cylinder 25 encircled by the rear collar 32 of the mount 13. Moreover, the bumper 39 has an inner diameter 54 which corresponds to the inner diameter of the front end of the neck 28. In this way, when an attachment 16 is applied to the mount 13, an engagement portion of the attachment 16, at the rear end of the attachment 16, is inserted and closely received both by the inner diameter of the front of the neck 28 and by the inner diameter 54 of the bumper 39. The bumper 39 has elastomeric, resilient, shock-absorbing material characteristics. The bumper 39 softens the impact of the piston 30 when the piston 30 moves forwardly and also provides a resilient, rebound force rearward on the piston 30 toward the rear end 21 of the body 11.

Referring now to FIG. 1F, when an attachment 16 such as the nosepiece 60 is fit into the mount 13, and the hammer 10 is operated, the reciprocating piston 30 repeatedly slams into the back of the attachment 16. And when a fastener is held in the nosepiece 60, this action hammers the fastener into the working surface until the fastener is sunk therein. Some attachments 16 incorporate reciprocating drivers. In attachments 16 that hammer fasteners—such as the nosepiece 60—the driver is carried within the attachment 16, the piston 30 hits the driver, and the driver hits the fastener. In other attachments 16, such as processing bits or tools of some of the later drawings, there may be no driver and the attachment 16 is instead a single piece, such that the piston hammers the rear end of the attachment 16 itself and so the entire attachment 16 is hammered.

The attachments 16 are all fit into the mount 13, which is an interface and engagement secured on the cylinder 25. The cylinder 25 has a cylindrical sidewall 27 which extends forwardly past the front end 20 of the body 11. Beyond the front end 20, the sidewall 27 constricts to a neck 28. The neck 28 is formed with externally-directed threads 29. A cylindrical plastic sleeve 37 has complemental internally-directed full-radius threads, and the sleeve 37 is threadably engaged onto the neck. The mount 13 is fixed to the sleeve 37 to secure the mount 13 on the cylinder 25.

The mount 13 includes an inner barrel 41 formed to a rear collar 32, and an outer sleeve 40 over the inner barrel 41. The inner barrel 41 and rear collar 32 form a one-piece cylindrical body. The larger-diameter rear collar 32 fits over the neck 28 of the cylinder 25, and the reduced-diameter inner barrel 41 projects axially in front of that collar 32. The outer sleeve 40 is a sliding, locking sleeve for securing attachments applied within the mount 13. The collar 32 and inner barrel 41 are coaxial to each other and formed monolithically from the same material or combination of materials.

The collar 32 is secured on and projects forwardly from the neck 28 of the cylinder 25. The mount 13 has a cylindrical sidewall 33, and so, along the collar 32, the sidewall 33 encircles the sleeve 37. Circumferentially spaced-apart bores are formed through the sidewall 33 (one can be seen in FIG. 1F), and set screws 38 are threadably engaged through the bores and into the sleeve 37, thereby fixing the collar 32 on the sleeve 37 and thus also on the cylinder 25. The collar 32 portion of the mount 13 terminates forwardly at a front flange 34. At the front flange 34, the sidewall 33 turns radially inwardly from the collar 32, extends inward to an inner diameter, and then turns back axially forward to form the inner barrel 41 projecting forwardly. The front flange 34 is disposed at and in contact with the sleeve 37 on the front of the neck 28 of the cylinder 25.

The mount 13 bounds a hollow interior 35 which has a larger diameter within the collar 32 (accommodating the neck 28 and the sleeve 37 thereon), but a smaller diameter within the inner barrel 41 in front of the collar 32. This smaller diameter is less than the outer diameter of the neck 28, such that the inner barrel 41—and thus the mount 13—cannot move over the neck 28. The hollow interior 35 is coaxial to the piston 30 and to the interior 26 in which the piston reciprocates. The full length of the hollow interior 35 receives an attachment 16 when it is applied to the mount 13. That attachment 16 extends through the interior 35, partially into the interior 26, is locked in place by the inner barrel 41 and a locking outer sleeve 40 on the inner barrel 41.

The inner barrel 41 is an inner barrel carrying the outer sleeve 40. The outer sleeve 40 moves or slides axially relative to the inner barrel 41 between advanced and retracted positions to arrange the mount 13 in either locked or unlocked conditions, respectively. The mount 13 is biased into the locked condition by a helical compression spring 42 disposed radially between the inner barrel 41 and outer sleeve 40, which biases the outer sleeve 40 forward into an advanced position with respect to the inner barrel 41. The outer sleeve 40 has a front end, a rear end, and an annular sidewall extending therebetween.

An engagement assembly 49 for locking an attachment 16 in the hollow interior 35 of the mount 13 is defined by the outer sleeve 40 and the inner barrel 41. Proximate to the front end of the outer sleeve 40, on an inner surface 47 thereof, partially-spherical depressions 44 extend into the body of the outer sleeve 40 from the inner surface 47 and are circumferentially spaced apart. Opposing these depressions 44, a set of circumferentially spaced-apart holes 50 are formed in and through the sidewall 33 in the inner barrel 41. Ball bearings 45 are carried in the holes 50 in the inner barrel 41 and are moved radially either into or out of these depressions 44 when the mount 13 is moved. Engagement and disengagement of the ball bearings 45 with the depressions 44 in this manner locks and unlocks the mount 13.

The inner surface 47 of the outer sleeve 40 slides smoothly along the outer surface of the inner barrel 41. The rear end of the outer sleeve 40 has a rearwardly-projecting collar 43 which is radially-spaced apart from the inner barrel 41, thereby defining an annular hold 46 at the rear end of the outer sleeve 40. This annular hold 46 captures the front end of the spring 42, with the rear end of the spring 42 against the front flange 34 of the mount 13. The spring 42 is therefore compressed between the outer sleeve 40 and the inner barrel 41, urging the outer sleeve 40 forward, away from the body 11 of the hammer 10. Again, this advanced position of the outer sleeve 40 constitutes a locked condition of the mount 13.

FIGS. 1D, 1E, 1F, and 1G all show the mount 13 in the locked condition. The outer sleeve 40 is slid forward and is prevented from further forward movement by confrontation with an annular ring 51 at the front of the barrel 41. As such, the depressions 44 are axially offset from the holes 50, and so the ball bearings 45 cannot move from the holes 50 into the depression 44. Rather, the ball bearings 45 are retained in the holes 50 in the inner barrel 41. Indeed, in this locked condition of the mount 13, the inner surface 47 of the outer sleeve 40 pushes or urges the ball bearings 45 into the holes 50 and toward the hollow interior 35. And when an attachment 16 is in the mount 13, the ball bearings 45 are pushed into the attachment 16, as shown in FIGS. 1F and 1G. When the outer sleeve 40 is in the advanced position thereof, the ball bearings 45 define a circle within the hollow interior 35 of the mount 13 having an inner diameter 55. A flange on the nosepiece 60 behind the ball bearings 45 has a larger diameter than this inner diameter 55, and this prevents the nosepiece 60 from coming loose from or falling out of the hammer 10.

The mount 13 allows quick change and replacement of different attachments 16. In some embodiments, the outer surface of the outer sleeve 40 is knurled to assist the worker in grasping the outer sleeve 40 when moving it between the advanced and retracted positions with respect to the inner barrel 41.

By moving the outer sleeve 40 backward into the retracted position, an attachment 16 can be released from the mount 13 and can be removed or replaced. FIG. 1H illustrates the outer sleeve 40 in this retraced position, unlocking the mount 13. To move the outer sleeve 40 into the retracted position with respect to the inner barrel 41 and thus place the mount 13 in the unlocked condition, the outer sleeve 40 is grasped by hand and pulled rearwardly, toward the body 11. The inner barrel 41 does not move, and so this relative axial movement of the outer sleeve 40 to the inner barrel 41 radially registers the depressions 44 over the holes 50 and the ball bearings 45 in the holes 50. As such, the retracted position of the outer sleeve 40 allows the ball bearings 45 to slightly displace radially out of the holes 50 and into the depressions 44.

When the ball bearings 45 are moved partially into the depressions 44, the attachment 16 can be removed; the attachment 16 is pulled from the mount with the flange on the attachment 16 clearing the ball bearings 45. This is described in more detail specifically with respect to the nosepiece 60 below.

Once an attachment 16 has been removed, the worker can release the outer sleeve 40. Releasing the outer sleeve 40 causes it to snap forward into the advanced position, moving the ball bearings 45 back into the holes 50, and re-arranging the mount 13 in the locked condition.

Turning now to FIGS. 2A-2C, a first attachment 16 is shown. This attachment, a nosepiece 60, is suitable for holding and guiding nails of approximately 3½ inches in length during hammering. The nosepiece 60 includes a driver 61, a base 62 fixed on the driver 61, and a guide 63 that slides over the driver 61. When the nosepiece 60 is installed in the hammer 10 and the hammer 10 is operated, the guide 63 quickly slides backward and forward on the driver 61, such that the driver 61 moves between an extended position (FIG. 2B) and a compressed position (FIG. 2C) within the guide 63. Expressed in another way, the guide 63 moves axially between an extended position (FIG. 2B) and a compressed position (FIG. 2c) on the driver 61 when the hammer 10 cycles the nosepiece 60.

The driver 61 is a rigid shaft carried in front of the piston 30 of the hammer 10 where it can be impacted cyclically and moved reciprocally. The driver 61 has a long, cylindrical, constant-diameter shank 64 extending from a front end 65 to a rear end 66. The driver 61 includes an axial flat 68 formed into its outer surface, the flat 68 extending from the front end 65 to a location generally intermediate between the front and rear ends 65 and 66. Just behind the front end 65, a pin 70 is firmly set into a transverse bore in the shank 64 of the driver 61. The pin 70 may be a split pin, slotted pin, or the like, and is just slightly longer than the outer diameter of the shank 64, such that opposed ends 71 of the pin 70 project beyond the outer surface of the shank 64. These ends 71 slide within slots in the guide 63.

Another pin 72 is firmly set into a bore just in front of the rear end 66. This pin 72 also has opposed ends 73 which project beyond the outer diameter of the shank 64. This pin 72 fixes the base 62 on the driver 61. The base 62 is a cylindrical collar fit onto the driver 61 and has varying inner and outer diameters.

The base 62 and part of the driver 61 cooperate to form an engagement portion 67 of the nosepiece 60, which engages with the mount 13 of the hammer 10. The base 62 is a sleeve fit over and fixed to the driver 61, defining the engagement portion 67 and capturing a spring 80. The engagement portion 67 includes the rear end 66 of the driver 61, a rear portion 74, a front portion 75, a flange 76, and a forward end 77. The rear portion 74 is part of the driver 61 extending between the front portion 75 and the rear end 66 of the driver 61. The rear portion 74 has an outer diameter 56, which is the smaller outer diameter of the engagement portion 67, but has the longest axial length. The rear portion 74 extends from the rear end 66 to the front portion 75, where the outer diameter increases. The front portion 75 is formed through with a bore that receives the pin 72. This pin 72 securely fixes the base 62 on the driver 61.

The front portion 75 extends axially forward to the flange 76, at which point the outer diameter increases again to an outer diameter 57. The rear and front portions 74 and 75 of the engagement portion 67 are sized and shaped to fit into the mount 13 of the hammer 10, and the flange 76 is sized to engage with the ball bearings 45 in the inner barrel 41 of the mount 13. The outer diameter 57 of the flange 76 is larger than the outer diameter of the front portion 75 and is larger than the inner diameter 55 defined by the ball bearings 45 when they are disposed within the holes 50 in the inner barrel 41. The forward end 77 is in front of the flange 76 and has a smaller diameter than the flange 76, a diameter which corresponds to that of the front portion 75.

Flanked by the smaller-diameter front portion 75 and forward end 77, the flange 76 thus constitutes an interference with respect to those ball bearings 45. Returning briefly to FIG. 1F, but with continuing reference to the elements identified in FIG. 2B, to apply the nosepiece 60 to the mount 13, the nosepiece 60 is taken up, such as by hand, and the rear end 66 of the driver 61 is directed toward the mount 13. The driver 61 is registered with the interior 35 and the nosepiece 60 is moved backward into the interior 35. The engagement portion 67 enters the interior 35 initially without interference. However, when at rest, the mount 13 is in the unlocked condition, the outer sleeve 40 is forward, and the ball bearings 45 are seated in the holes 50 in the barrel 41 and biased inwardly, and so when the flange 76—which has the larger outer diameter 57 than the inner diameter 55 defined by the ball bearings 45—encounters the ball bearings 45, the ball bearings must be displaced. The worker pulls the outer sleeve 40 backward to register the depressions 44 in the outer sleeve 40 with the holes 50 in the inner barrel 41, and when the flange 76 is moved into and against the ball bearings 45, they are displaced slightly into the depressions 44 to allow the flange 76 past. Once the flange 76 has slipped past the ball bearings 45, the worker releases the outer sleeve 40, which snaps back into its advanced condition, and the inner surface 47 of the outer sleeve 40 pushes the ball bearings 45 back into the holes 50.

Now, the ball bearings 45 are in contact with the forward end 77, and the flange 76 is behind the ball bearings 45. The nosepiece 60 cannot inadvertently come out of the mount 13, because the smaller inner diameter defined by the ball bearings 45 prevents the flange 76 from moving axially forward. Unless the worker moves the mount 13 into the unlocked condition, the nosepiece 60 is secured in the mount 13.

Under the base 62, below the flange 76 and the forward end 77, there is an annular space 78 defined between the inner diameter of the base 62 and the outer diameter of the driver 61. This annular space 78 receives a helical compression spring 80 which is carried over the shank 64 of the driver 61. The spring is compressed between the base 62 and the guide 63 and serves to bias the guide 63 forwardly away from the base 62. The spring 80 is closely fit around the shank 64.

The guide 63 is a sleeve fit over the driver 61; it has a front end 81, a rear end 82, and an elongate cylindrical sidewall 83 extending therebetween. The sidewall 83 bounds and defines an interior which is in open communication with a muzzle or opening. The guide 63 has a front end 81, a rear end 82, and an elongate cylindrical sidewall 83 extending therebetween. The sidewall 83 bounds and defines an interior 84 which is in open communication with a muzzle or opening 85 at the front end 81 and an opening at the rear end 82. The inner diameter of the sidewall 83 is constant along its length between the front and rear ends 81 and 82. It closely receives the shank 64 of the driver 61 when the driver reciprocates within the interior 84.

The front end 65 of the driver 61 is fit within the interior 84. Slots 86 (best shown in FIG. 2A) are formed into the sidewall 83 on opposed sides of the guide 63. The slots 86 extend axially along nearly the entire length of the guide 63, and each receives one of the ends 71 of the pin 70. The pins 70 thus guide reciprocal movement of the driver 61 in the guide 63. The front end 65 of the driver 61 is set into the interior 84, and the slots 86 do not extend fully to the rear end 82 of the guide 63, so that the driver 61 overlaps with the guide 63 and remains within the guide 63 at all times and in all positions of its reciprocating cycle.

The guide 63 will accept and house a fastener 15, preferably a 3½″ nail. Indeed, the guide 63 holds and guides a fastener 15 which is applied thereto in front of the driver 61. The guide 63 has a smooth inner surface, and the inner diameter of the guide 63 corresponds roughly to the size of the head of a 3½″ nail. Of course, other inner diameters are contemplated within the spirit and scope of this disclosure to receive heads of other sizes. Three axially-aligned bores are formed through the sidewall 83 of guide 63; in each of these bores a magnet 87 is applied and fixed, preferably with an epoxy or other adhesive. Two magnets 87 are disposed in the sidewall of the guide 63 proximate the front end 81 and one is proximate the rear end 82. The magnets 87 are directed inward to magnetically attract and loosely hold the fastener after it has been inserted into the interior 84 of the guide 63. The magnets 87 are sufficiently strong to retain the fastener in the interior 84 when the driver 61 is not reciprocating, but are not so strong that the driver 61 cannot move the fastener out of the interior to drive it into a working surface 19. While attraction of the fastener is desired, it is not beneficial to attract the driver 61 while it is reciprocating, as this can cause its cycling to slow down. The flat 68 formed into the outer surface of the shank 64 spaces the metal of the driver 61 sufficiently apart from the magnets 87 that the reciprocation of the driver 61 is not affected by magnetic attraction.

When a fastener 15 is inserted into the guide 63, and the nosepiece 60 is applied to the hammer 10, the hammer 10 can drive the fastener 15. The front end 81 of the guide 63 is formed with several prongs 88. These prongs 88 bite into the working surface 19 during operation of the hammer 10 to steady the hammer 10. Generally, the fastener 15 is muzzle-loaded, head first, through the opening 85, and the tip of the fastener 15 extends slightly past prongs 88. With the driver 61 in the extended position, the fastener 15 is inserted nearly entirely into the guide 63.

The nosepiece 60 not only holds the fastener 15 but guides it during hammering. Briefly, as the hammer 10 operates, the fastener 15 is driven into the working surface 19. As the fastener 15 is driven into the working surface 19, the guide 63 recedes and moves rearwardly over the shank 64 of the driver 61. Thus, the guide 63 moves from the extended position, shown in FIG. 2B, to the compressed position, shown in FIG. 2C. In the extended position, the rear end 82 of the guide 63 is located at the front end 65 of the driver 61. The spring 80 is fully extended around the shank 64 of the driver 61.

At all times, the guide 63 surrounds the fastener 15 above the working surface 19. When the fastener 15 is initially placed within the guide 63, the guide 63 surrounds nearly the entire length of the fastener 15; as can be seen in FIGS. 2B and 2C, with the fastener 15 loaded into the guide 63 and the guide 63 in the extended position thereof, the tip of the fastener 15 extends just beyond the prongs 88 of the guide 63. The worker sets the tip of the fastener 15 in the desired spot on the working surface 19 and then raises the hammer 10 to the desired angle with respect to the working surface 19. The tip of the fastener 15 may push slightly into the working surface 19 and become sunk therein, thereby establishing an anchor point for the hammer 10. The entire length of the fastener 15 above the working surface 19 is within the guide 63, encircled by its sidewall 83.

Once the hammer 10 is readied in this fashion, the worker depresses the trigger 14. Depressing the trigger 14 causes pressurized gas to be cyclically provided and exhausted into and out of the interior 26 of the hammer 10, in front of and behind the piston 30, to cause the piston 30 to reciprocate quickly. The piston 30 repeatedly slams against or impacts the rear end 66 of the driver 61.

FIGS. 1F and 1G show the relative positions of the driver 61 and the piston 30 during hammering. As can be seen first in FIG. 1F, the rear end 66 of the driver 61 extends, in interference, approximately five millimeters into the interior 26 where the piston 30 moves, such that the strokes of the piston 30 and driver 61 overlap by five millimeters. FIG. 1F shows a fully-retraced position on the driver 61. The front portion 75 is in contact with the front of the neck 28, preventing further rearward movement of the driver 61. The rear end 66 of the driver 61 extends beyond the front of the neck 28, through the central bore 53 of the bumper 39, and just past the bumper 39 into the interior 26; the rear end 66 is approximately one millimeter past the bumper 39 in FIG. 1F. FIG. 1F also shows the piston 30 moving axially forwardly in the interior 26. The front end of the piston 30 has just encountered the rear end 66 of the driver 61, but has not fully advanced inside the cylinder 25. As such, there is a slight annular gap between the front end of the piston 30 and the bumper 39.

The front end of the piston 30 encounters and impacts the rear end 66 of the driver. As shown in FIG. 1G, the driver 66 and piston 30 together move axially forward. FIG. 1G illustrates the fully advanced position of the piston 30; the piston 30 encounters the bumper 39 and compresses it slightly, but is prevented by the bumper 39 from further forward axial movement. The driver 61 is not so encumbered, however, and so the driver 61 will continue to move forward until the flange 76 encounters the ball bearings 45. The smaller inner diameter 55 of the ball bearings 45 prevents the flange 76 from moving further axially forward, and with the worker pushing the hammer 10 downward, the fastener 15 pushes the driver 61 back toward the rear end 21 of the hammer 10. This resets the driver position as the piston 30 continues to cycle. As such, the driver 61 again is placed into the retracted position shown in FIG. 1F, and the piston 30 reciprocates to hit and move the driver 61 forward. As the piston 30 repeatedly slams against the rear end 66 of the driver 61, the driver 61 repeatedly hammers the head of the fastener, causing the fastener 15 to drive into the working surface 19. The guide 63 moves more over the driver 61, and the spring 80 compresses as the base 62 moves toward the guide 63.

As the piston 30 continues to cycle and the driver 61 continues to hammer the fastener into the working surface 19, the guide 63 must recede rearwardly on the driver 61. The front end 81 of the guide 63 is pressed against the working surface 19 and this imparts movement along the arrowed line A in FIG. 2B of the guide 63 over the driver 61. As the guide 63 so recedes, the front end of the spring 80 compresses. The rear end of the spring 80 is held in place within the annular space 78 of the base 62. The effective length of the nosepiece 60, between the front end 81 of the guide 63 and the rear end 66 of the driver 61, thus begins to shorten and the nosepiece 60 collapses to accommodate the hammering of the fastener 15.

While the nosepiece 60 collapses, the guide 63 continues to surround the fastener 15 above the working surface 19. Of course, as the hammer operates, it drives the fastener 15 further into the working surface 19 and the fastener moves increasingly from within the guide 63 to below the working surface 19.

As long as the worker continues to hold down the trigger 14, the piston 30 continues to cycle. The worker depresses the trigger 14 preferably until the fastener 15 is fully sunk into the working surface 19. When the fastener 15 is fully sunk, the guide 63 is fully receded into its compressed position, and the front end 65 of the driver 61 is just beyond the prongs 88 of the guide 63. Preferably, the front end 65 extends approximately one millimeter beyond the prongs 88 of the guide 63. When the worker lets off the trigger 14, the piston 30 stop moving, and the worker can draw the hammer 10 off the fastener 15. When that occurs, the spring 80 elongates and pushes the guide 63 forward, back to its extended position.

If the worker is done with the nosepiece 60, it can be removed and a new fastener 15 can be muzzle loaded and driven in the manner described above. To remove the nosepiece 60, the worker grips the outer sleeve 40 and pulls it backward over the inner barrel 41. This registers the depressions 44 over the holes 50. The worker then also grabs the nosepiece 60 and pulls it outward from the hammer 10. When the nosepiece 60 is pulled from the hammer 10, the flange 76 moves forward in the hollow interior 35. The flange 76 pushes the ball bearings 45 radially outward so that they displace into the depressions 44. When the ball bearings 45 are fully seated in the depressions 44, they define an inner diameter which allows the flange 76 to continue to move forward, out of the interior 35. Once the flange 76 has cleared the ball bearings 45, the worker can release the outer sleeve 40. The spring 42 pushes the outer sleeve 40 back to its advanced position, and the mount 13 is returned to a locked condition. The worker may then apply another attachment 16 as described above.

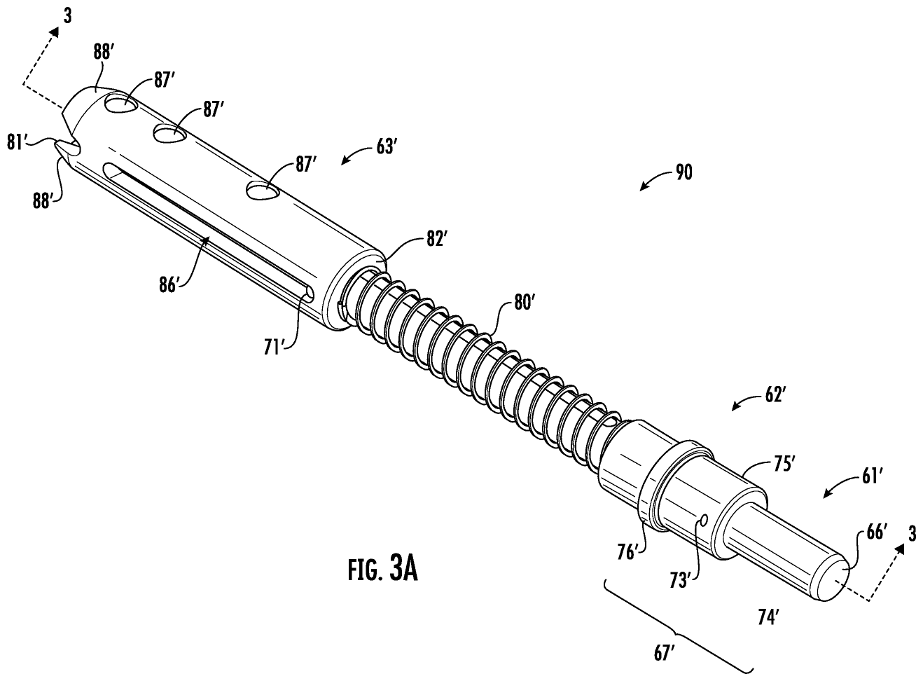

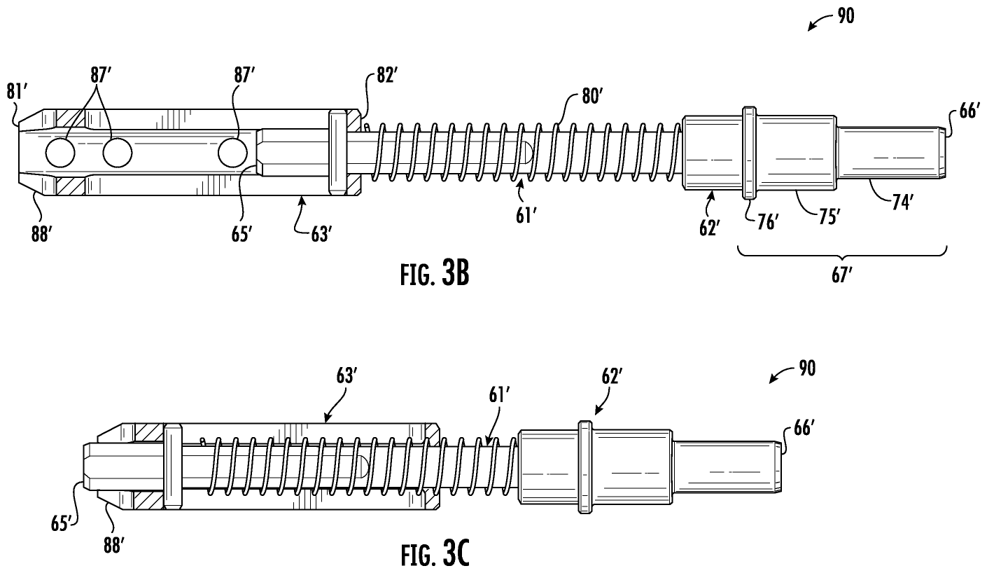

Turning now to FIGS. 3A-3C, another attachment 16 is shown. This attachment, a nosepiece 90, is suitable for driving nails of approximately 2½ inches in length. The nosepiece 90 is nearly identical to the nosepiece 60 but for size. As such, structural elements and features that are common to both nosepieces 60 and 90 are referred to with the same names and reference characters, but those of the nosepiece 90 are marked with a prime (“′”) symbol to distinguish them from those of the nosepiece 60. Further, for those structural elements and features which are identical, no detailed description is presented here, as the structure and function will be understood by the foregoing description. Moreover, the drawings of FIGS. 3A-3C are slightly different than those of FIGS. 2A-2C; they show slightly different views and may use fewer reference characters. These drawings illustrate the nosepiece 60 and the nosepiece 90 in different ways to provide a more robust disclosure of each.

Accordingly, the nosepiece 90 includes a driver 61′, base 62′, and guide 63′. These three constituent elements are identical to the corresponding driver 61, base 62, and guide 63 of the nosepiece 60, but have slightly different proportions. Further, the guide 63 is slightly different at its front end, as will be explained. The nosepiece 90 also includes, at least, shank 64′, front and rear ends 65′ and 66′, engagement portion 67′, flat 68′, pin 70′, ends 71′, pin 72′, ends 73′, rear portion 74′, outer diameter 56′ of the rear portion 74′, front portion 75′, flange 76′, outer diameter 57′ of the flange 76′, forward end 77′, annular space 78′, spring 80′, front end 81′, rear end 82′, sidewall 83′, interior 84′, opening 85′, slot 86′, magnets 87′, and prongs 88′.

As can be seen in the drawings, the nosepiece 90 is slightly shorter than the nosepiece 60. Further, the magnets 87′ are disposed in different locations. While there are still three magnets 87′, the two forward magnets 87′ are further forward on the guide 63 than are the magnets 87 in the nosepiece 60, and the rear magnet 87′ is further from the rear end 82′ than the rear magnet 87 is to the rear end 82. The prongs 88′ also have a different shape than the prongs 88. While the prongs 88 are each fairly slender, separated by wide gaps, the prongs 88′ are wider and separated by smaller gaps.

Operation of the nosepiece 90 is nearly the same as operation of the nosepiece 60. When the trigger 14 of the hammer 10 is depressed, the piston 30 repeatedly slams into the rear end 66′ of the driver 61′, until the guide 63′ is fully retracted over the driver 61′ and the fastener is sunk into the working surface. When the guide 63′ is compressed over the driver 61′, the front end 65′ of the driver 61′ projects out beyond the prongs 88′ of the guide 63′. This ensures that the driver 61′ fully cycles and extends to drive the fastener.

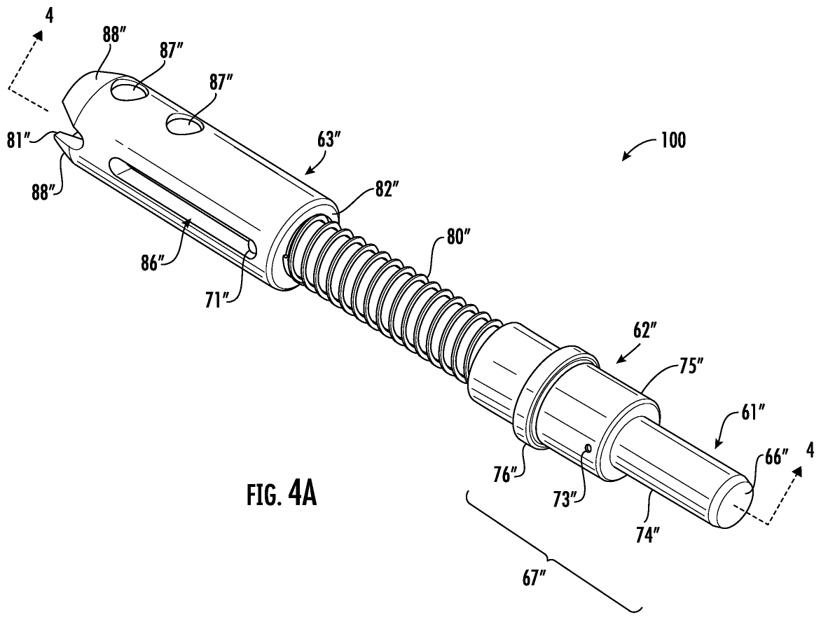

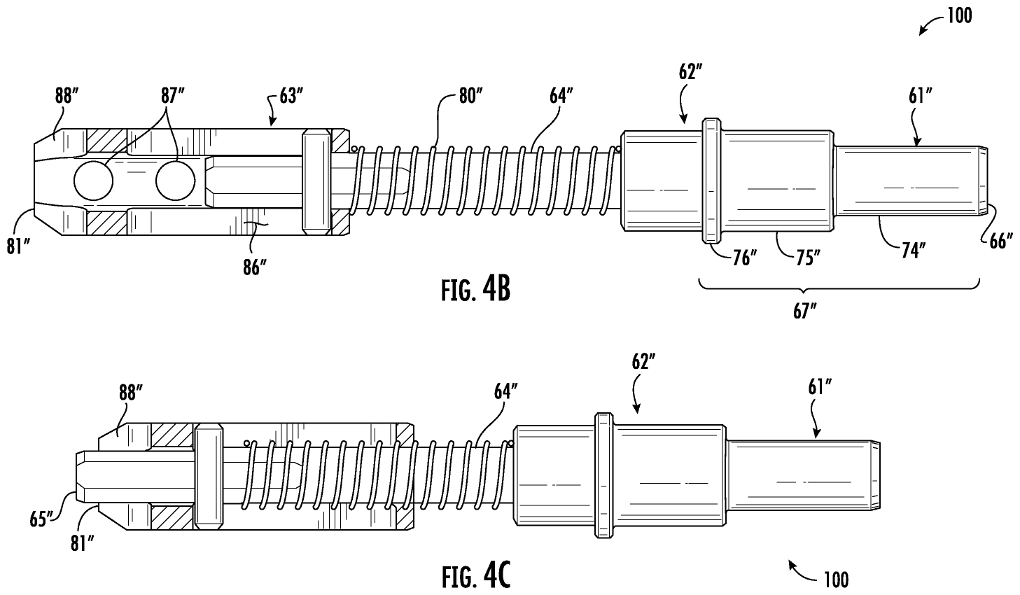

Turning now to FIGS. 4A-4C, another attachment 16 is shown. This attachment, a nosepiece 100, is suitable for driving nails of approximately 1½ inches in length. The nosepiece 100 is nearly identical to the nosepieces 60 and 90 but for size. As such, structural elements and features that are common to both nosepieces 60 and 100 are referred to with the same names and reference characters, but those of the nosepiece 100 are marked with a double-prime (“″”) symbol to distinguish them from those of the nosepiece 60. Further, for those structural elements and features which are identical, no detailed description is presented here, as the structure and function will be understood by the foregoing description. Moreover, the drawings of FIGS. 4A-4C are slightly different than those of FIGS. 2A-2C; they show slightly different views and may use fewer reference characters. These drawings illustrate the nosepiece 60 and the nosepiece 100 in different ways to provide a more robust disclosure of each.

Accordingly, the nosepiece 100 includes a driver 61″, base 62″, and guide 63″. These three constituent elements are identical to the corresponding driver 61, base 62, and guide 63 of the nosepiece 60, but have slightly different proportions. Further, the guide 63 is slightly different at its front end, as will be explained. The nosepiece 100 also includes, at least, a shank 64″, front and rear ends 65″ and 66″, engagement portion 67″, flat 68″, pin 70″, ends 71″, pin 72″, ends 73″, rear portion 74″, outer diameter 56″ of the rear portion 74″, forward portion 75″, flange 76″, outer diameter 57″ of the flange 76″, forward end 77″, annular space 78″, spring 80″, front end 81″, rear end 82″, sidewall 83″, interior 84″, opening 85″, slot 86″, magnets 87″, and prongs 88″.

As can be seen in the drawings, the nosepiece 100 is slightly shorter than the nosepiece 60. Further, the magnets 87″ are different in number and location. While there are three magnets 87 on the nosepiece 60, there are only two magnets 87″ on the nosepiece 100. The two magnets 87″ are disposed proximate the front end 81″ and are closer to the front end 81″ than are the two magnets 87 which are proximate to the front end 81. The nosepiece 100 has not magnet 87 proximate the rear end 82″. The prongs 88″ of the nosepiece 100 have a different shape than the prongs 88, a shape which is identical to the prongs 88′ on the nosepiece 90. While the prongs 88 are each fairly slender, separated by wide gaps, the prongs 88″ are wider and separated by smaller gaps.

Operation of the nosepiece 100 is nearly the same as operation of the nosepiece 60. When the trigger 14 of the hammer 10 is depressed, the piston 30 repeatedly slams into the rear end 66″ of the driver 61″, until the guide 63″ is fully retracted over the driver 61″ and the fastener is sunk into the working surface. When the guide 63″ is compressed over the driver 61″, the front end 65″ of the driver 61″ is flush with the front end 81″ of the of the guide 63″.

Attention is now directed to FIG. 5, which is a perspective view of another attachment, a processing tool 110 useful for scraping working surfaces. The tool 110 has a front end 111, a rear end 112, and a shank 113 extending from the rear end 112 to a scraper 119 processing implement at the front end 111. The tool 110 is one-piece, constructed integrally and monolithically from a material or combination of materials having strong, rigid, rugged, and durable characteristics, such as steel, iron, or like metals.

The shank 113 is generally cylindrical along its length between the front and rear ends 111 and 112, and generally has a constant outer diameter, except as described here. The shank 113 and scraper 119 are formed integrally and monolithically to each other. The front end 111 of the tool 110 is forked: two prongs 114 extend forwardly and are spaced apart by a slot 115. The prongs 114 are blunt and have flat edges 116 aligned transverse to the length of the shank 113. The slot 115 is a V-shaped slot with its narrow end directed toward the rear end 112 of the tool 110 and its wide end open at the front end 111 between the two flat edges 116.

Two long, low, multi-angled bevels 117 and 118 extend rearward from the flat edges 116 of the prongs 114. From the flat edges 116, the bevel 117 is oriented approximately transversely. Just in front of the narrow end of the slot 115, the bevel 117 increases its angle with respect to the flat edges 116, aligning nearly parallel with the length of the shank 113. Then, from a distance approximately twice as large as the length of the slot 115, the bevel 117 changes its angle again, increasing more with respect to the flat edges 116, and extending rearwardly through the shank 113 until it terminates. The bevel 118 has a similar profile on the opposite side of the tool 110. The bevels 117 and 118 allow the prongs 114 and the slot 115 to engage with a working surface at an angle offset from the length of the tool 110. This structure at the front end 111 of the tool 110 is the processing implement and defines the scraper 119: the bevels 117 and 118, the prongs 114, the slot 115, and the flat edges 116. The tool 110 can be slid, scraped, or ground across the working surface to lift material, fasteners, and other elements on the working surface. Moreover, the slot 115 is effective at pulling nails. The shank of a partially-sunk nail is positioned in the slot 115, with the head of the nail against either of the bevels 117 and 118, and positioning the other of the bevels 117 and 118 against the working surface in which the nail is partially-sunk. The tool 110 then can be angled and operated to lift and remove the nail from the working surface.

The processing tool 110 has an engagement portion 120 allowing the tool 110 to be fit into and engaged with the hammer 10. The engagement portion 120 includes a flange 121 formed proximate the rear end 112 and the shank 113 between the flange 121 and the rear end 112. The flange 121 is a radially-outward extension of the shank 113; it has a larger outer diameter than the rest of the shank 113. The flange 121 has a forward-facing annular sloped face 122 and an opposite, rear-facing annular sloped face 123. The rear face 123 has a gentler, longer slope than does the forward face 122. Indeed, the forward face 122 is a tight fillet between the outer cylindrical surface of the shank 113 and the flange 121, while the rear face 123 extends approximately four times further back on the tool 110 from the flange 121 than does the forward face 122 extend forwardly on the tool 110.

The engagement portion 120 also includes the rear end 112, as well as a rear portion 124 of the shank 113 between the flange 121 and the rear end 112. This engagement portion 120 fits into the mount 13 and becomes secured therein. The rear portion 124 has an outer diameter which is smaller than the outer diameter of the flange 121 and is also smaller than the inner diameter 55 defined by the ball bearings 45. The outer diameter of the flange 121 is larger than the inner diameter 55. When the tool 110 is pushed into the mount 13, with its rear end 112 directed toward the hammer 10, and the shank 113 registered with the interior 35 of the mount 13, the outer diameter of the flange 121 contacts and is blocked by the ball bearings 45. The mount 13 is in a locked condition, and so a worker pulls the outer sleeve 40 backward to register the depressions 44 in the outer sleeve 40 with the holes 50 in the inner barrel 41. Then, when the flange 121 is moved into and against the ball bearings 45, they are displaced slightly into the depressions 44 to allow the flange 121 past. Once the flange 121 has slipped past the ball bearings 45, the worker releases the outer sleeve 40, which snaps back into its advanced condition, and the inner surface 47 of the outer sleeve 40 pushes the ball bearings 45 back into the holes 50.

Now, the ball bearings 45 are in contact with the shank 113, and the flange 121 is behind the ball bearings 45. The processing tool 110 cannot inadvertently come out of the mount 13, because the smaller inner diameter defined by the ball bearings 45 prevents the flange 121 from moving axially forward. Unless the worker moves the mount 13 into the unlocked condition, the tool 110 is secured in the mount 13.

Once so secured, the hammer 10 can be taken up by hand and the trigger 14 depressed to cycle the processing tool 110. The piston 30 repeatedly slams against the rear end 112, causing the tool 110 to reciprocate quickly. When the tool 110 is placed against a working surface, such as a concrete slab covered with old wood flooring, the tool 110 works under the flooring, scraping the flooring off the slab.

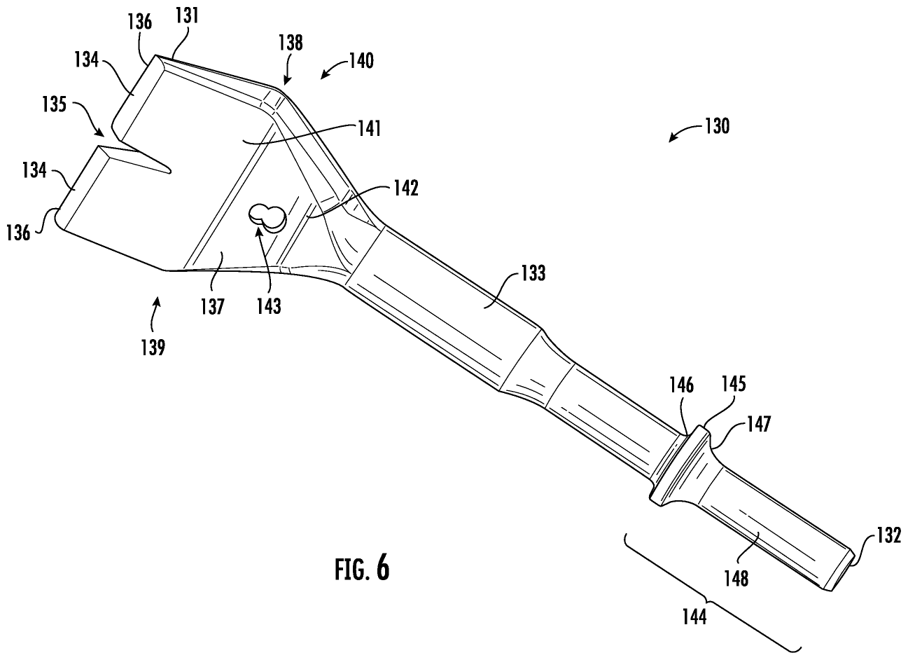

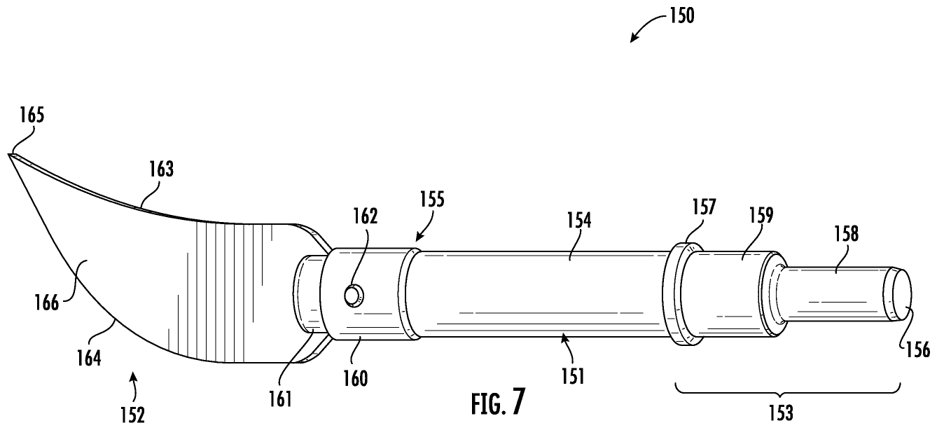

With reference now to FIG. 6, another attachment is shown for use with the hammer: a processing tool 130 useful for scraping working surfaces is shown in perspective view. The tool 130 has a front end 131, a rear end 132, and a shank 133 extending from the rear end 132 to a processing implement at the front end 131 identified as a scraper 139. The tool 130 is one-piece, constructed integrally and monolithically from a material or combination of materials having strong, rigid, rugged, and durable characteristics, such as steel, iron, or like metals.

The shank 133 is generally cylindrical along its length between the front and rear ends 131 and 132. The front end 131 of the tool 130 is wide and is forked: two prongs 134 extend forwardly and are spaced apart by a slot 135. The prongs 134 are wide; each is about three times wider than the prongs 114. The prongs 134 are also blunt and have flat edges 136 aligned transverse to the length of the shank 133. The slot 135 is a V-shaped slot with its narrow end directed toward the rear end 132 of the tool 130 and its wide end open at the front end 131 between the two flat edges 136.

Two long, low, multi-angled bevels 137 and 138 extend rearward from the flat edges 136 of the prongs 134. From the flat edges 136, the bevel 137 is oriented approximately transversely and extends first to a distance approximately twice as large as the length of the slot 135. There, the bevel 137 changes its angle, increasing with respect to the flat edges 136, and extending rearwardly through the shank 133 until it terminates. The bevel 138 has a similar profile on the opposite side of the tool 130, is not visible, but should be understood from the description of the bevels 138, 117, and 118. The bevels 137 and 138 terminate in the same axial location on the tool 130 set back from the front end 131, albeit opposed from each other. The bevels 137 and 138 allow the prongs 134 and the slot 135 to engage with a working surface at an angle offset from the length of the tool 130. This structure at the front end 131 of the tool 130 is the processing implement and defines the scraper 139: the bevels 137 and 138, the prongs 134, the slot 135, and the flat edges 116.

The tool 130 can be slid, scraped, or ground across the working surface to lift material, fasteners, and other elements on the working surface. Moreover, the slot 135 is effective at pulling nails. The shank of a partially-sunk nail is positioned in the slot 135, with the head of the nail against either of the bevels 137 and 138, and positioning the other of the bevels 137 and 138 against the working surface in which the nail is partially-sunk. The tool 130 then can be angled and operated to lift and remove the nail from the working surface.

The prongs 134 are quite wide, so as to define a flat head 140 at the front end 131 of the tool 130. Indeed, the prongs 134 are more correctly defined as parts of the flat head 140 formed by the slot 135. The flat head 140 has a wide face 141 and a smaller triangular face 142. The wide face 141 corresponds to the first angled pitch of the bevel 137, and the triangular face 142 corresponds to the second angled pitch of the bevel 137. There is also a wide face and a triangular face on the opposite side of the tool 110. A slotted hole 143 is formed in the triangular face 142, entirely through the head 140. The slotted hole 143 includes a smaller front bore and a larger rear bore, formed proximate each other and in communication with each other. The slotted hole 143 is useful as a nail-puller; the larger rear bore can be fit over the large head of nail, the tool 130 can be slid backward so that the shank of the nail is disposed in the smaller front bore and the head outside the slotted hole 143, and then the tool 130 can be turned or torqued upwardly, so as to use the shank 133 as a lever arm and pull the nail out of the working surface.

The processing tool 130 has an engagement portion 144 allowing the tool 130 to be fit into and engaged with the hammer 10. The engagement portion 144 includes a flange 145 formed proximate the rear end 132 and the shank 133 between the flange 145 and the rear end 132. The flange 145 is a radially-outward extension of the shank 133; it has a larger outer diameter than much of the shank 133. The flange 145 has a forward-facing annular sloped face 146 and an opposite, rear-facing annular sloped face 147. The rear face 147 has a gentler, longer slope than does the forward face 146. Indeed, the forward face 146 is a tight fillet between the outer cylindrical surface of the shank 133 and the flange 145, while the rear face 147 extends approximately four times further back on the tool 130 from the flange 145 than does the forward face 146 extend forwardly on the tool 130.

The engagement portion 144 also includes the rear end 132 as well as a rear portion 148 of the shank 133 between the flange 145 and the rear end 132. This engagement portion 144 fits into the mount 13 and becomes secured therein. As with the tool 110, the flange 145 of the tool 130 has a larger outer diameter than the inner diameter 55 of the ball bearings 45, while the outer diameter of the rear portion 148 is smaller. When the tool 130 is pushed into the mount 13, with its rear end 132 directed toward the hammer 10, the engagement portion 144 of the tool 130 fits into the mount 13 and engages with the mount 13 in an identical fashion as the engagement portion 120 of the tool 110, as described above. As such, discussion of such engagement is not necessary here.

Once the tool 130 is secured in the mount 13, the hammer 10 can be taken up by hand and the trigger 14 depressed to cycle the processing tool 130. The piston 30 repeatedly slams against the rear end 132, causing the tool 130 to reciprocate quickly. When the tool 130 is placed against a working surface, such as a concrete slab covered with old wood flooring, the tool 130 works under the flooring, scraping the flooring off the slab.

FIG. 7 illustrates another attachment, a processing tool known as a fencing staple remover 150. The remover 150 includes a shank 151 and a processing implement fit into the shank 151. The processing implement is a blade 152 fixed securely into the shank 151 and is useful for slipping under and prying loose staples.

The shank 151 is an elongate cylinder. It includes an engagement portion 153 and a shaft 154 extending forwardly to a chuck 155. In the engagement portion 153, the shank 151 has a rear portion 158 with a first outer diameter, which rear portion 158 extends from a rear end 156 of the shank 151 to a location approximately halfway between the rear end 156 and a flange 157. The shank 151 has a middle portion 159 with a second outer diameter, which middle portion 159 extends from this approximately halfway position forwardly to the flange 157. The second outer diameter is larger than the first outer diameter. The rear and middle portions 158 and 159 of the engagement portion 153 are sized and shaped to fit into the hammer 10 and be received for engagement therein. The engagement portion 153 terminates forwardly with the flange 157. The flange 157 has an outer diameter which is larger than the second outer diameter of the middle portion of the engagement portion 153.

In front of the flange 157, the outer diameter of the shank 151 is the same as the second outer diameter of the middle portion of the engagement portion 153. This outer diameter is constant, and the outer surface of the shank 151 is cylindrical and smooth, until the chuck 155. The chuck 155 includes an outer sleeve 160 which is integrally and monolithically formed as part of the shank 151, but the sleeve 160 is hollow, with an opening at its axial end. A cylindrical base 161 of the blade 152 is fit into the sleeve 160, and a pin 162 through the sleeve 160 and the base 161 secures the base 161 in the sleeve 160.

The blade 152 is formed integrally and monolithically to the cylindrical base 161 as an extension thereof. The blade 152 is planar, extending away from the base 161 as a flat implement. The blade 152 has an inner edge 163 and an opposed outer edge 164. The inner edge 163 is shorter than the outer edge 164 and has a concave shape while the outer edge 164 has a convex shape. While the inner and outer edges 164 and 164 are both flat and blunt, as shown in FIG. 7, the inner and outer edges 163 and 164 meet at a sharp tip 165 of the blade 152 which overhands the inner edge 163. The blade 152 also has opposed sides 166 which are flat, planar, parallel to each other, and meet at the inner and outer edges 163 and 164. As shown in FIG. 7, the sides 166 are spaced apart from each other such that the blade 152 has a substantial thickness.

To apply the remover 150 to the hammer 10, it is registered with the interior 35 of the mount 13 and moved into the interior 35. The worker moves the outer sleeve 40 of the mount 13 into the retracted position so that the mount 13 is unlocked and the flange 157 may move past the ball bearings 45. The worker then releases the outer sleeve 40, thereby returning the mount 13 to the locked condition with the remover 150 engaged therein.

In use, the remover 150 is effective at slipping under fencing staples and removing them from a working surface. The sharp tip 165 of the blade 152 can slide under the crown of the staple, and the reciprocal movement of the blade 152 then pries and lifts the staple loose from the working surface.

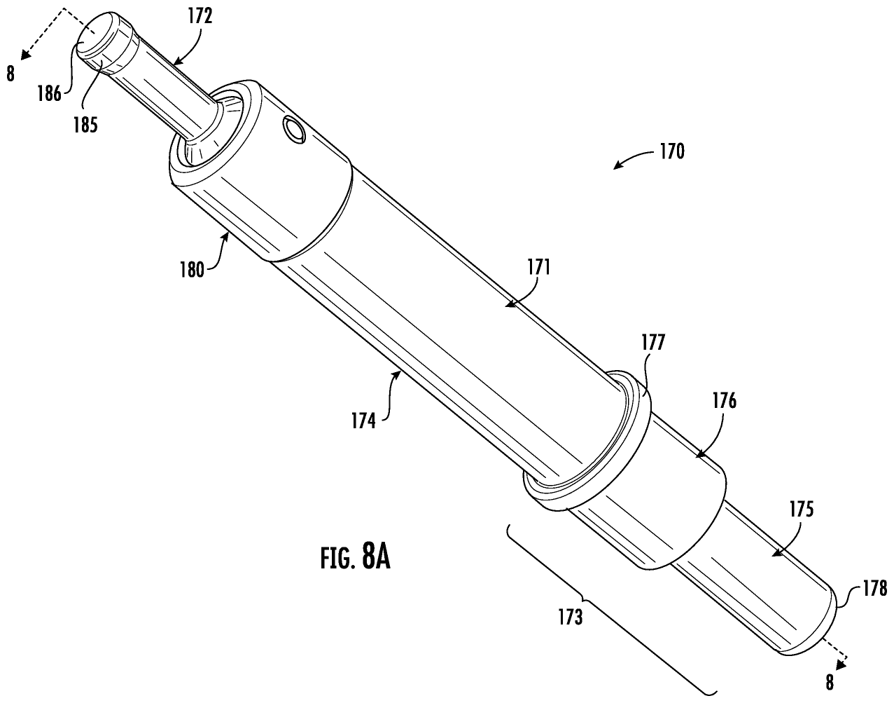

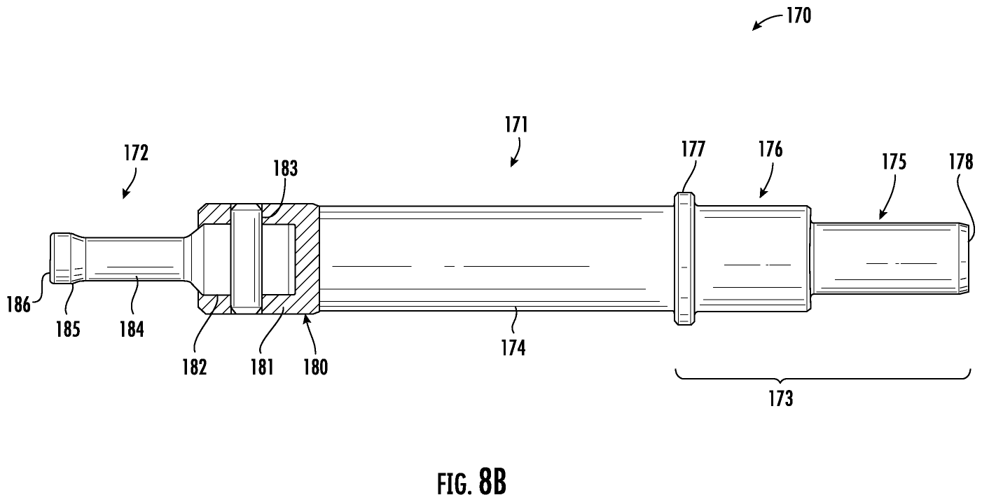

FIGS. 8A and 8B illustrate another attachment or processing tool known as a punch or de-nailer 170. The de-nailer 170 includes a shank 171 and a punch 172 fit into the shank 171. The punch 172 is a processing implement, fixed into the shank 171 securely and useful for punching nails through working surfaces such as planks and other pieces of lumber.

The shank 171 is an elongate cylinder having several different outer diameters. It includes an engagement portion 173 and a shaft 174 extending forwardly to a chuck 180.

The engagement portion 173 includes a rear portion 175, a front portion 176, a flange 177, and a rear end 178 of the shank 171. The rear portion 175 and front portion 176 are of approximately the same axial length, but have different diameters: the rear portion 175 has a smaller diameter than does the front portion 176. The rear portion 175 extends axially from the rear end 178 of the shank 171 to the front portion 176, at which point the diameter of the shank 171 increases. The front portion 176 then extends axially to the flange 177, where the diameter of the shank 171 again increases.

The rear and front portions 175 and 176 of the engagement portion 173 are sized and shaped to fit into the hammer 10, and the flange 177 is sized to engage with the ball bearings 45 within the mount 13. The engagement portion 173 terminates forwardly with the flange 177. The flange 177 has an outer diameter which is larger than the outer diameter of the front portion 176. This flange 177 has a larger outer diameter than the inner diameter 55 of the ball bearings 45, and thus constitutes an interference with respect to the ball bearings 45.

In front of the flange 177, the outer diameter of the shank 171 is the same as the outer diameter of the front portion 176. This outer diameter is constant, and the outer surface of the shank 171 is cylindrical and smooth, until a chuck 180. The chuck 180 includes an outer sleeve 181 which is integrally and monolithically formed as part of the shank 171, but the sleeve 181 is hollow, with an opening at its axial forward end.

The punch 172 has a cylindrical base 182. The base 182 is set into and snugly received in the hollow sleeve 181. A pin 183 locks the base 182 in the sleeve 181; the pin 183 extends through a hole in the sleeve 181, a bore through the base 182, and another hole in the sleeve 181. The pin 183 secures the punch 172 in the shank 171.

The punch 172 is formed integrally and monolithically to the cylindrical base 182 as an extension thereof. The punch 172 is a cylinder of varying diameter. From the base 182, the diameter of the punch 172 decreases slightly along a neck 184. The diameter increases at a head 185 at the front of the punch 172, though the diameter at the head 185 is not as large as the diameter at the base 182. The head 185 terminates with a flat face 186 which is transverse to the length of the punch 172.

To apply the de-nailer 170 to the hammer 10, it is registered with the interior 35 of the mount 13 and moved into the interior 35. The worker moves the outer sleeve 40 of the mount 13 into the retracted position so that the mount 13 is unlocked and the flange 177 may move past the ball bearings 45. The worker then releases the outer sleeve 40, thereby returning the mount 13 to the locked condition with the de-nailer 170 engaged therein.

In use, the de-nailer 170 is effective at punching nails through working surfaces such as planks and other pieces of lumber. Once the de-nailer 170 is set into the hammer 10, the hammer 10 is picked up by hand and the face 186 is placed atop the head of a nail to be driven. The worker depresses the trigger 14 and the hammer operates, causing the de-nailer 170 to reciprocate quickly. When the worker presses the hammer 10 into the nail, the reciprocating de-nailer 170 punches the nail through the working surface until the nail emerges, free, on the other side.

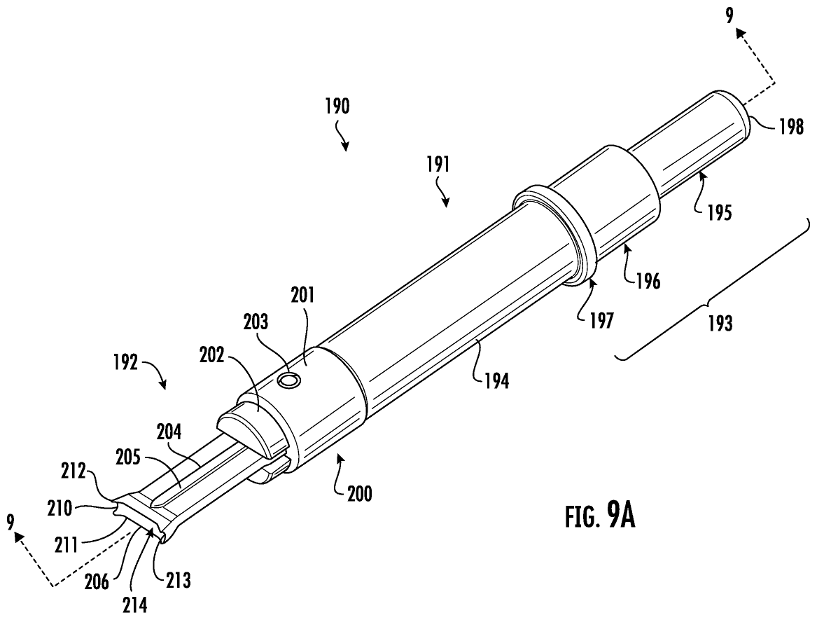

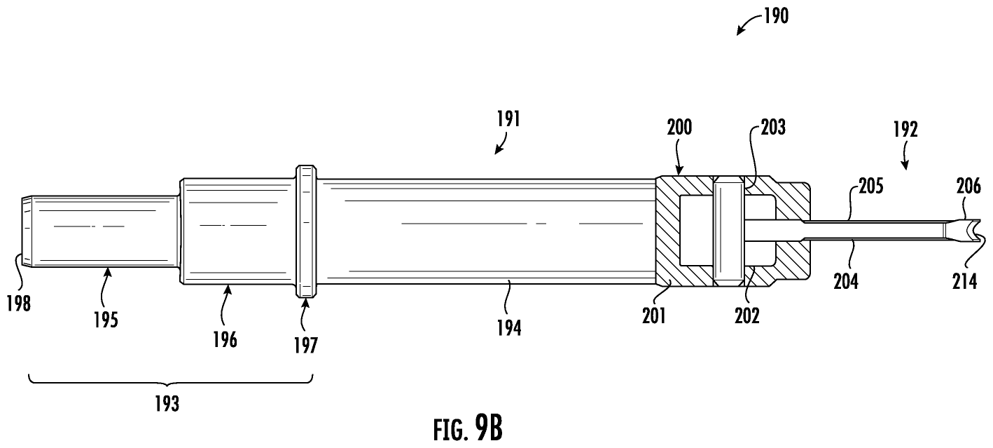

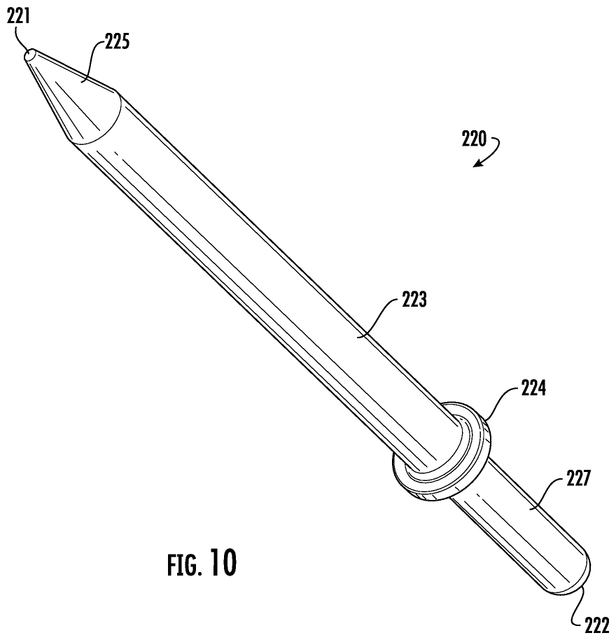

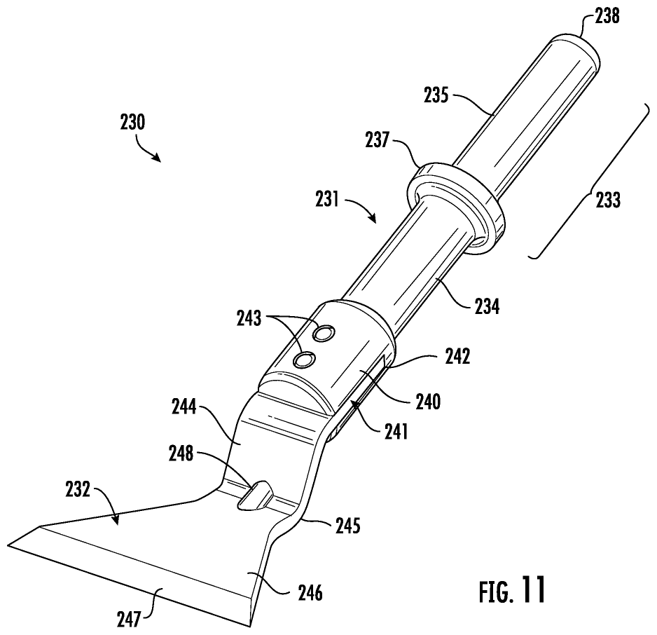

FIGS. 9A and 9B illustrate another attachment or processing tool known as a de-stapler 190. The de-stapler 190 includes a shank 191 and a punch 192 fit into the shank 191. The punch 192 is a processing implement fixed into the shank 191 securely and is useful for punching staples through working surfaces such as planks and other pieces of lumber.

The shank 191 is an elongate cylinder having several different outer diameters. It includes an engagement portion 193 and a shaft 194 extending forwardly to a chuck 200.

The engagement portion 193 includes a rear portion 195, a front portion 196, a flange 197, and a rear end 198 of the shank 191. The rear portion 195 and front portion 196 are of approximately the same axial length but have different diameters: the rear portion 195 has a smaller diameter than does the front portion 196. The rear portion 195 extends axially from the rear end 198 of the shank 191 to the front portion 196, at which point the diameter of the shank 191 increases. The front portion 196 then extends axially to the flange 197, where the diameter of the shank 191 again increases.

The rear and front portions 195 and 196 of the engagement portion 193 are sized and shaped to fit into the hammer 10, and the flange 197 is sized to engage with the ball bearings 45 within the mount 13. The engagement portion 193 terminates forwardly with the flange 197. The flange 197 is a ring formed integrally and monolithically on the shank 191. The flange 197 has an outer diameter which is larger than the outer diameter of the front portion 196. This flange 197 has a larger outer diameter than the inner diameter 55 of the ball bearings 45, and thus constitutes an interference with respect to the ball bearings 45.

In front of the flange 197, the outer diameter of the shank 191 is the same as the outer diameter of the front portion 196. This outer diameter is constant, and the outer surface of the shank 191 is cylindrical and smooth, until a chuck 200. The chuck 200 includes an outer sleeve 201 which is integrally and monolithically formed as part of the shank 191, but the sleeve 201 is hollow, with an opening at its axial forward end.

The punch 192 has a base 202 shaped generally like a cylinder severed hemispherically. The base 202 is set into and snugly received in the hollow sleeve 201. A pin 203 locks the base 202 in the sleeve 201; the pin 203 extends through a hole in the sleeve 201, a bore through the base 202, and another hole in the sleeve 201. The pin 203 secures the punch 192 in the shank 191.

The punch 192 is formed integrally and monolithically to the base 202 as an extension thereof. The punch is a projection having a flat and thin arm 204 extending forwardly from the base 202. The arm 204 has opposed upper and lower major faces, each of which is bifurcated by a stiffening ridge 205 extending axially from the base 202. At the front end of the punch 192 is a saddle 206 size and shaped to receive the crown of a staple. The saddle 206 has opposed long edges 210 and 211 projecting forwardly, parallel to each other. Between the long edges 210 and 211, at the ends thereof, are short edges 212 and 213. Defined between all of these edges 210-213 is a valley or recess 214, into which the crown of the staple is received.

To apply the de-stapler 190 to the hammer 10, it is registered with the interior 35 of the mount 13 and moved into the interior 35. The worker moves the outer sleeve 40 of the mount 13 into the retracted position so that the mount 13 is unlocked and the flange 197 may move past the ball bearings 45. The worker then releases the outer sleeve 40, thereby returning the mount 13 to the locked condition with the de-stapler 190 engaged therein.

In use, the de-stapler 190 is effective at punching staples through working surfaces such as planks, wood-flooring planks, and other pieces of lumber. Once the de-stapler 190 is set into the hammer 10, the hammer 10 is picked up by hand and the saddle 206 is placed atop the crown of a staple to be driven. The worker depresses the trigger 14 and the hammer operates, causing the de-stapler 190 to reciprocate quickly. When the worker presses the hammer 10 into the staple, the reciprocating de-stapler 190 punches the staple through the working surface until the staple emerges, free, on the other side.

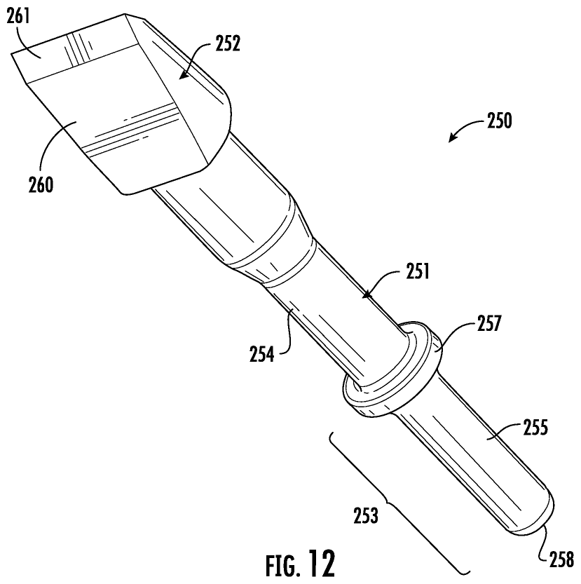

FIG. 10 illustrates another attachment: a conical processing tool 220. The tool 220 includes a front end 221, a rear end 222, and a shank 223 extending from the rear end 222 to a processing implement at the front end 221 of the tool 220. The shank 223 has the same diameter over its entire length, except for a flange 224 proximate the rear end 222 and a tip 225 at the front end 221. The flange 224 is an annular disc projecting radially outward from the shank 223 and thus has an outer diameter which is larger than that of the rest of the shank 223.

At the front end 221, the tip 225 is conical. The diameter of the shank 223 narrows from its diameter along most of its length to a point at the front end 221. The tip 225 is a processing implement of the tool 220 and is useful for boring and breaking a working surface.

The processing tool 220 has an engagement portion allowing the tool 220 to be fit into and engaged with the hammer 10. The engagement portion 226 includes the flange 224, the rear end 222, and a rear portion 227 of the shank 223 between the flange 224 and the rear end 222. This engagement portion 226 fits into the mount 13 and becomes secured therein. The rear portion 227 has an outer diameter which is smaller than the outer diameter of the flange 224 and is also smaller than the inner diameter 55 defined by the ball bearings 45. The outer diameter of the flange 224 is larger than the inner diameter 55.

To apply the tool 220 to the hammer 10, it is registered with the interior 35 of the mount 13 and moved into the interior 35. The worker moves the outer sleeve 40 of the mount 13 into the retracted position so that the mount 13 is unlocked and the flange 224 may move past the ball bearings 45, as described above with respect to other attachments. The worker then releases the outer sleeve 40, thereby returning the mount 13 to the locked condition with the tool 220 engaged therein.

Once the tool 220 is set into the hammer 10, the hammer 10 is picked up by hand and the tip 225 is placed on a working surface. The worker depresses the trigger 14 and the hammer 10 operates, causing the tool 220 to reciprocate quickly. When the worker presses the tool 220 into the working surface, the reciprocating tool 220 punches the surface repeatedly, boring holes and breaking the surface apart.

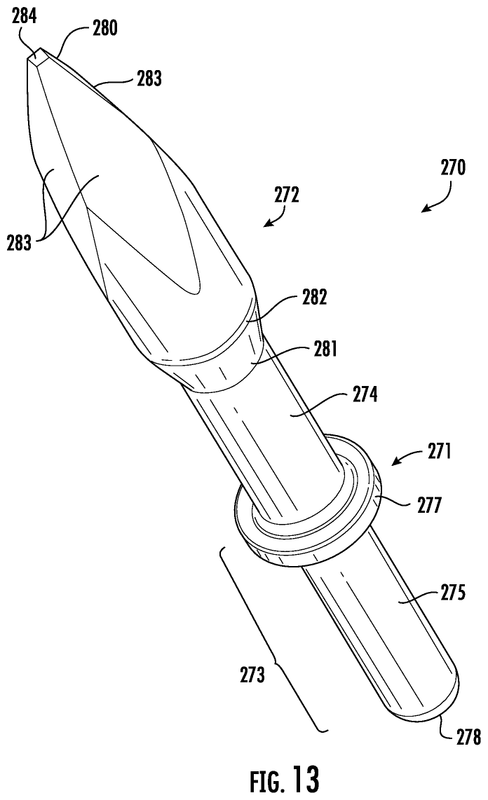

FIG. 11 illustrates a wide-scraping attachment 230. The attachment 230 includes a shank 231 and a processing implement, identified as a scraper 232, fit into the shank 231. The scraper 232 is fixed into the shank 231 securely and is useful for scraping material from working surfaces.

The shank 231 is an elongate cylinder having several different outer diameters. It includes an engagement portion 233 and a shaft 234 extending forwardly to a chuck 240. The engagement portion 233 includes a rear end 238 of the shank 231, a rear portion 235, and a flange 237. The rear portion 235 extends axially from the rear end 238 of the shank 231 to the flange 237, at which point the diameter of the shank 231 increases. The flange 237 is a ring formed integrally and monolithically on the shank 231. The engagement portion 233 terminates forwardly with the flange 237.

The rear portion 235 of the engagement portion 233 is sized and shaped to fit into the hammer 10, and the flange 237 is sized to engage with the ball bearings 45 within the mount 13. The outer diameter of the flange 237 is larger than the inner diameter 55 of the ball bearings 45 when the mount 13 is locked, but when the flange 237 is pushed into the ball bearings 45 and the mount 13 is unlocked, the ball bearings 45 are displaced. This flange 237 constitutes an interference with respect to the ball bearings 45.

In front of the flange 237, the outer diameter of the shank 231 is slightly larger than the outer diameter of the rear portion 235. This outer diameter is constant, and the outer surface of the shank 231 is cylindrical and smooth, until a chuck 240. The chuck 240 is integrally and monolithically formed as part of the shank 231. The chuck 240 is severed, however, by a slot 241 formed entirely through the chuck between opposed sides thereof, and the slot 241 extending axially into the chuck 240 nearly to the rear end of the chuck 240.

The scraper 232 has a thin, flat base 242. The base 242 is set into and snugly received in the slot 241. Two pins 243 lock the base 242 in the slot 241; each pin 243 extends through a bore in the slot 241, a hole through the base 242, and another bore in the slot 241 on the opposite side of the base 242. The pins 243 secure the scraper 232 in the shank 231.

The scraper 232 is formed integrally and monolithically to the cylindrical base 242 as an extension thereof. Indeed, the scraper 232 is a thin sheet of rigid, strong metal; it is stamped or die-cut and then into the shape of the scraper 232. It includes a neck 244 which extends out from the base 242 and bends downward at an angle away from the plane of the base 242. At a valley or inflection point 245, the neck 244 connects to a head 246 of the scraper 232. An axial ridge 248 in the inflection point 245 increases the strength and rigidity of the inflection point 245. The head 246 is angled oppositely to the neck 244, and as it extends from the neck 244, it widens obliquely to a terminal scraping edge 247. The scraping edge 247 is parallel to the plane of the neck 244.

To apply the attachment 230 to the hammer 10, it is registered with the interior 35 of the mount 13 and moved into the interior 35. The worker moves the outer sleeve 40 of the mount 13 into the retracted position so that the mount 13 is unlocked and the flange 237 may move past the ball bearings 45. The worker then releases the outer sleeve 40, thereby returning the mount 13 to the locked condition with the attachment 230 engaged therein.

In use, the attachment 230 is effective at scraping a working surface. Once the attachment 230 is set into the hammer 10, the hammer 10 is picked up by hand and the scaping edge 247 is placed against the working surface. The worker depresses the trigger 14 and the hammer operates, causing the attachment 230 to reciprocate quickly. When the worker presses the hammer 10 into and along the working surface, the reciprocating attachment 230 scrapes across the working surface to lift material and other elements from the working surface.

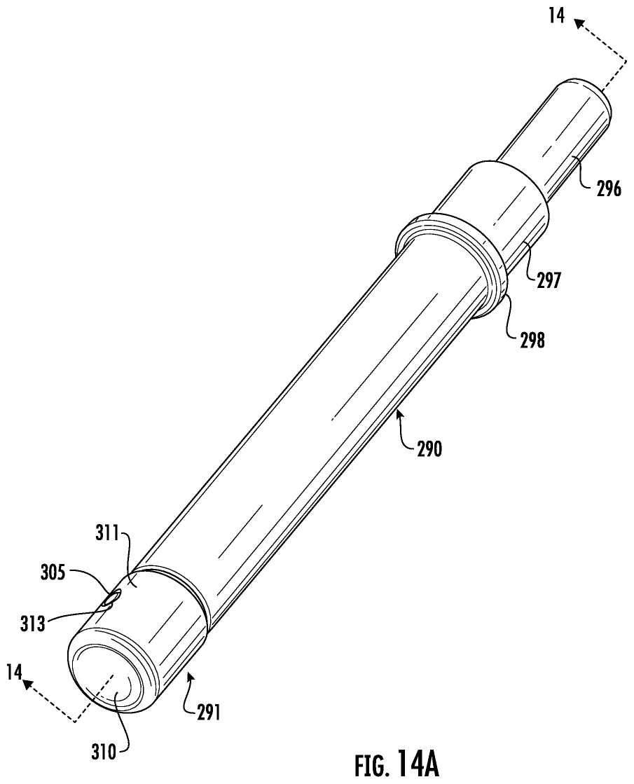

FIG. 12 illustrates another attachment or processing tool: a chiseling tool 250. The tool 250 includes a shank 251 and a processing implement, identified as a chisel 252, fit into the shank 251. The chisel 252 is formed to the shank 251 securely and is useful for chiseling pieces of a working surface.

The shank 251 is an elongate cylinder having several different outer diameters. It includes an engagement portion 253 and a shaft 254 extending forwardly to the chisel 252. The engagement portion 253 includes a rear end 258 of the shank 251, a rear portion 255, and a flange 257. The rear portion 255 extends axially from the rear end 258 of the shank 251 to the flange 257, at which point the diameter of the shank 251 increases. The flange 257 is a ring formed integrally and monolithically on the shank 251.

The rear portion 255 of the engagement portion 253 is sized and shaped to fit into the hammer 10, and the flange 257 is sized to engage with the ball bearings 45 within the mount 13. The engagement portion 253 terminates forwardly with the flange 257. This flange 257 has a larger outer diameter than the inner diameter 55 of the ball bearings 45, and thus constitutes an interference with respect to the ball bearings 45.

In front of the flange 257, the outer diameter of the shank 251 is slightly larger than the outer diameter of the rear portion 255. This outer diameter increases behind the chisel 252, and the outer surface of the shank 251 is cylindrical and smooth. The chisel 252 is integrally and monolithically formed as part of the shank 251. The chisel 252 has opposed convergent faces 260 (one is shown in the drawing) which meet at a chisel edge 261. The chisel 252 is slightly wider than the shank 251, but one having ordinary skill in the art will readily appreciate that the chisel 252 could be narrower or wider in alternate embodiments. Moreover, the chisel edge 261 could have a single-edge grind, a double-edge grind, convex grind, hollow, flat, or sabre grind, bevel grind, compound bevel grind, or some other edge common to chisels and other knife-like instruments.

To apply the tool 250 to the hammer 10, it is registered with the interior 35 of the mount 13 and moved into the interior 35. The worker moves the outer sleeve 40 of the mount 13 into the retracted position so that the mount 13 is unlocked and the flange 257 may move past the ball bearings 45. The worker then releases the outer sleeve 40, thereby returning the mount 13 to the locked condition with the tool 250 engaged therein.

In use, the tool 250 is effective at chiseling out portions of a working surface. Once the tool 250 is set into the hammer 10, the hammer 10 is picked up by hand and the chisel edge 261 is placed against the working surface. The worker depresses the trigger 14 and the hammer operates, causing the tool 250 to reciprocate quickly. When the worker presses the hammer 10 into the working surface at angle, the reciprocating tool 250 will chisel out chunks of the working surface to remove it from the working surface.

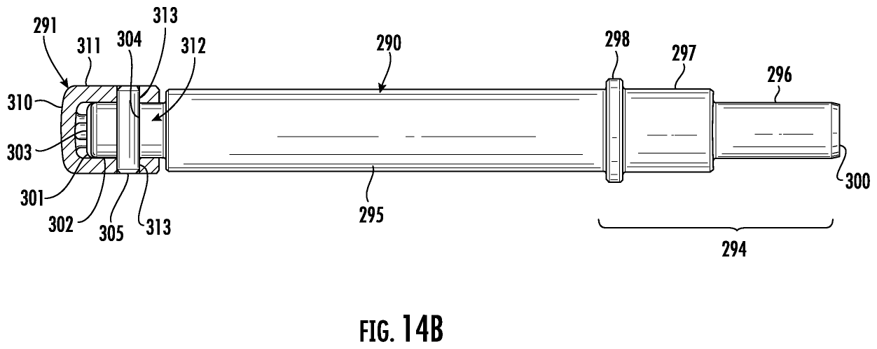

FIG. 13 illustrates another attachment for the hammer 10: a chipping tool 270. The tool 270 includes a shank 271 and a processing implement, identified as a chipper 272, fit into the shank 271. The chipper 272 is formed to the shank 271 securely and is useful for chipping large chunks of material from a working surface.

The shank 271 is an elongate cylinder having a few different outer diameters. It includes an engagement portion 273 and a shaft 274 extending forwardly to the chipper 272. The engagement portion 273 includes a rear end 278 of the shank 271, a rear portion 275, and a flange 277. The rear portion 275 extends axially from the rear end 278 to the flange 277, at which point the diameter of the shank 271 increases. The flange 277 is a ring formed integrally and monolithically on the shank 271.

The rear portion 275 of the engagement portion 273 is sized and shaped to fit into the hammer 10, and the flange 277 is sized to engage with the ball bearings 45 within the mount 13. The engagement portion 273 terminates forwardly with the flange 277. This flange 277 has a larger outer diameter than the inner diameter 55 of the ball bearings 45, and thus constitutes an interference with respect to the ball bearings 45.

In front of the flange 277, the outer diameter of the shank 271 is slightly larger than the outer diameter of the rear portion 275. From the flange 277 forward to the chipper 272, the shaft 274 has a constant outer diameter and a smooth, cylindrical outer surface. The chipper 272 is integrally and monolithically formed as part of the shank 271. The chipper 272 has a front end 280, an opposed rear end 281, and a middle band 282 therebetween. The rear end 281 is formed to the shank 271. From the rear end 281 to the middle band 282, the outer diameter of the tool 270 expands gradually and constantly, and maintains a circular cross-section. At the middle band 282, the outer diameter of the tool 270 is at its largest. From the middle band 282 forward, the chipper 272 narrows slightly, until four oblique faces 283 form bevels into the front of the chipper 272. These bevels are oriented axially, and are each arranged transverse with respect to their neighbor, such that they converge to a small square point 284 at the front end 280 of the chipper 272.

To apply the tool 270 to the hammer 10, it is registered with the interior 35 of the mount 13 and moved into the interior 35. The worker moves the outer sleeve 40 of the mount 13 into the retracted position so that the mount 13 is unlocked and the flange 277 may move past the ball bearings 45. The worker then releases the outer sleeve 40, thereby returning the mount 13 to the locked condition with the tool 270 engaged therein.

In use, the tool 270 is effective at chipping out portions of a working surface. Once the tool 270 is set into the hammer 10, the hammer 10 is picked up by hand and the point 284 is placed against the working surface. The worker depresses the trigger 14 and the hammer operates, causing the tool 270 to reciprocate quickly. When the worker presses the hammer 10 into the working surface at angle, the reciprocating tool 270 will chipper out chunks of the working surface to remove it from the working surface.

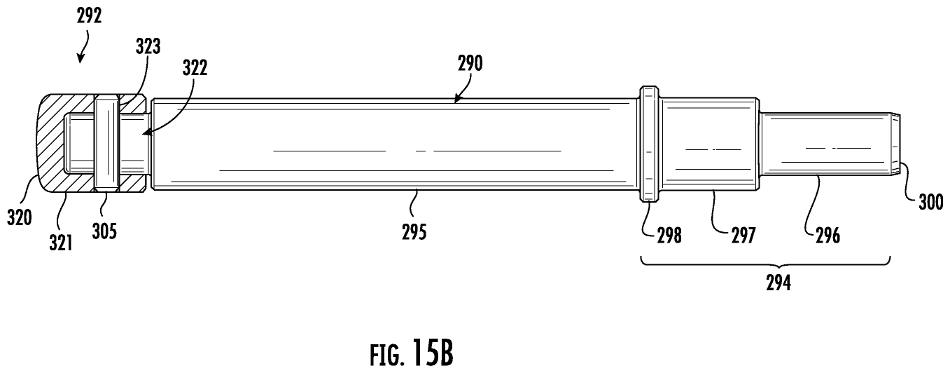

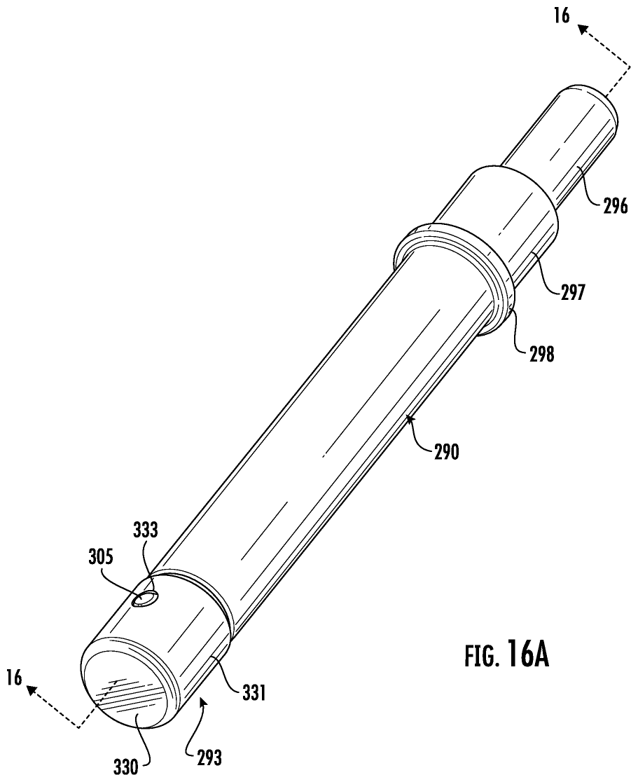

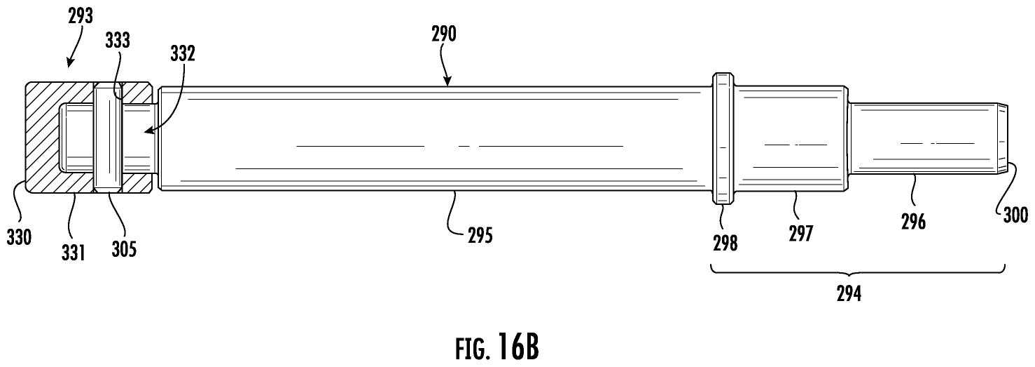

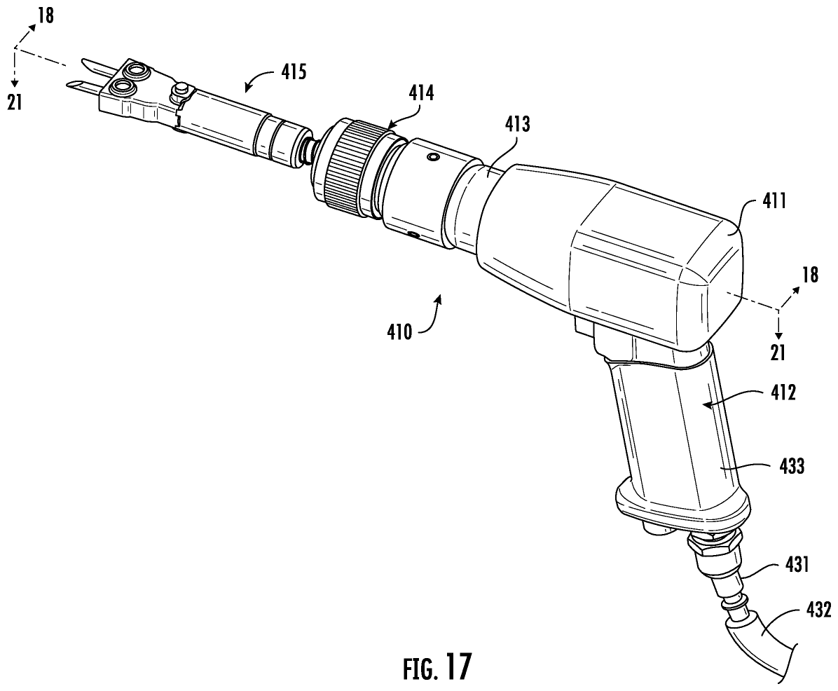

FIGS. 14A-16B show three different attachments for hammering. Each has a different type of processing implement fit on the same shank 290. FIGS. 14A and 14B illustrate a soft hammer head 291 on the shank 290, FIGS. 15A and 15B illustrate a convex hammer head 292 on the shank 290, and FIGS. 16A and 16B illustrate a flat hammer head 293 on the shank 290.

With reference to FIGS. 14A and 14B, the shank 290 is an elongate cylinder having a few different outer diameters. It includes an engagement portion 294 and a shaft 295 extending to the soft hammer head 291. The engagement portion 294 includes a rear end 300 of the shank 290, a rear portion 296, a front potion 297, and a flange 298. The rear portion 296 and front portion 297 are of approximately the same axial length, but have different diameter; the rear portion 296 has a smaller diameter than does the front portion 297. The rear portion 296 extends axially from the rear end 300 of the shank 290 to the front portion 297, where the diameter of the shank 290 increases. The front portion 297 then extends axially to the flange 298, where the diameter of the shank 290 again increases.

The rear and front portions 296 and 297 of the engagement portion 294 are sized and shaped to fit into the hammer 10, and the flange 298 is sized to engage with the ball bearings 45 within the mount 13. The engagement portion 294 terminates forwardly with the flange 298. The flange 298 is a ring formed integrally and monolithically on the shank 290. The flange 298 has an outer diameter which is larger than the outer diameter of the front potion 297. This flange 298 has a larger outer diameter than the inner diameter 55 of the ball bearings 45, and thus constitutes an interference with respect to the ball bearings 45.

In front of the flange 298, the outer diameter of the shank 290 is the same as the outer diameter of the front portion 297. This outer diameter is constant, and the outer surface of the shank 290 is cylindrical and smooth, until a post 302 at a front end 301 of the shank 290.

The post 302 is a reduced-diameter, co-axial projection of the shank 290. It is formed integrally and monolithically as part of the shank 290, and it projects out from the shank 290 to the front end 301 thereof. The post 302 projects forwardly to a flat face 303, transverse to the length of the shank 290. A bore 304 is formed parallel to this face 303, through the post 302. This bore 304 receives a pin 305 that binds the soft hammer head 291 to the post 302.

The soft hammer head 291 is a cup fit over the post 302. It is constructed from a material or combination of materials having soft, elastomeric, resilient qualities, such as rubber or soft plastic. It has a front face 310 and a sidewall 311 extending rearwardly therefrom. The front face 310 is slightly convex, forming a slight outward curve or bow extending forward. The front face 310 has a small rounded corner transitioning to the sidewall 311. The sidewall 311 extends rearwardly nearly to the shank 290. The sidewall 311 is cylindrical, defining an open socket 312 bound by the sidewall 311. When the soft hammer head 291 is fit onto the post 302, the socket 312 is snugly received on the post 302. The pin 305 is passed through opposed holes 313 in the sidewall 311 to securely engage the soft hammer head 291 on the post 302. A small gap 314 is formed between the flat face 303 of the post 302 and the inner surface of the socket 312, just behind the front face 310. While the material of the soft hammer head 291 can be deformed, this gap 314 provides additional deformation to the soft hammer head 291 when it impacts a working surface, fastener, or other element that the hammer 10 is hammering the head 291 against.

Turning to FIGS. 15A and 15B, the convex hammer head 292 is a cup fit over the post 302. It is constructed from a material or combination of materials having hard, durable, rugged, rigid qualities, such as steel, iron, or other like metals. It has a front face 320 and a sidewall 321 extending rearwardly therefrom. Like the front face 310, the front face 320 is slightly convex, forming a slight outward curve or bow extending forward. The front face 320 has a small rounded corner transitioning to the sidewall 321. The sidewall 321 extends rearwardly nearly to the shank 290. The sidewall 321 is cylindrical, defining an open socket 322 bound by the sidewall 321. When the convex hammer head 292 is fit onto the post 302, the socket 322 is fully and snugly received on the post 302. The pin 305 is passed through opposed holes 323 in the sidewall 321 to securely engage the convex hammer head 292 on the post 302. The head 292 is hard, and is useful for pounding nails, staples, and other fasteners into a working surface.

FIGS. 16A and 16B show the flat hammer head 293, which is a cup fit over the post 302. It is constructed from a material or combination of materials having hard, durable, rugged, rigid qualities, such as steel, iron, or other like metals. It has a front face 330 and a sidewall 331 extending rearwardly therefrom. The front face 330 is flat, transverse to the length of the shank 290. The front face 330 has a small rounded corner transitioning to the sidewall 331. The sidewall 331 extends rearwardly nearly to the shank 290. The sidewall 331 is cylindrical, defining an open socket 332 bound by the sidewall 331. When the flat hammer head 293 is fit onto the post 302, the socket 332 is fully and snugly received on the post 302. The pin 305 is passed through opposed holes 333 in the sidewall 331 to securely engage the flat hammer head 293 on the post 302. The head 293 is hard, and is useful for pounding nails, staples, and other fasteners into a working surface.

The shank 290, fit with any of the heads 291, 292, or 293, is applied to the hammer 10 for use. To apply the shank 290 to the hammer 10, it is registered with the interior 35 of the mount 13 and moved into the interior 35. The worker moves the outer sleeve 40 of the mount 13 into the retracted position so that the mount 13 is unlocked and the flange 298 may move past the ball bearings 45. The worker then releases the outer sleeve 40, thereby returning the mount 13 to the locked condition with the shank 290 engaged therein.

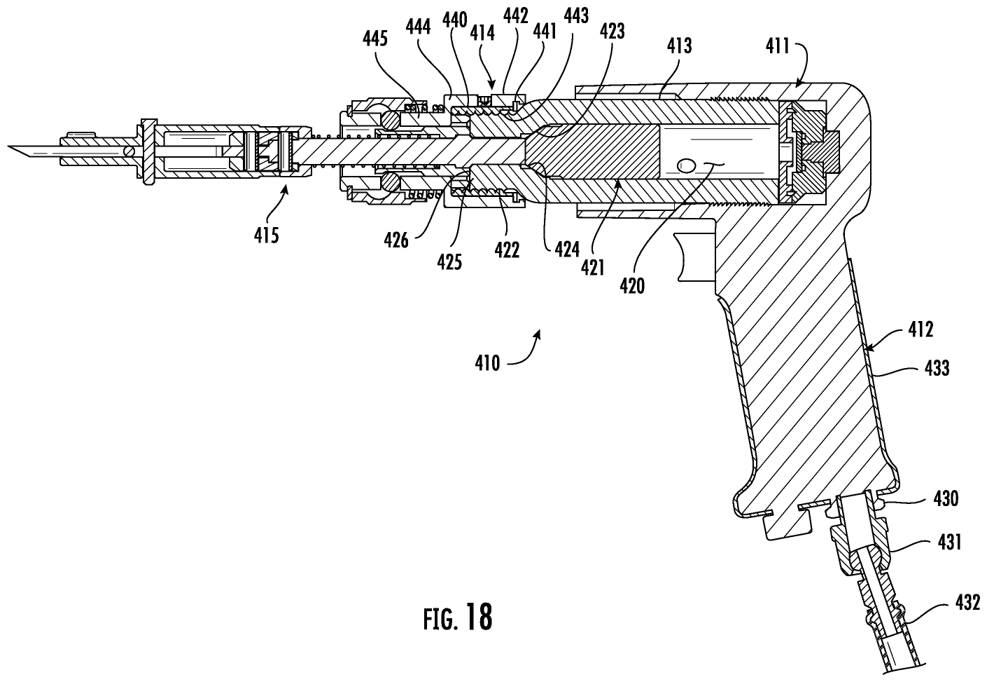

FIG. 17 shows another embodiment. FIG. 17 is a top perspective view of a powered staple tool (hereinafter, the “tool” 410). The tool 410 includes a body 411 and a handle 412 formed monolithically to the body 411.

The body 411 of the tool 410 is a large hollow housing, constructed from a molded sidewall of very hard, rigid, rugged, and durable material or combination of materials, such as high-density plastic or metal. The body 411 surrounds and protects the internal componentry of the tool 410 and provides mounting locations for such componentry. The body 411 holds a cylinder 413 threadably engaged within the body 411 and extending beyond a front end of the body 411. The rear end of the cylinder 413 has outwardly-directed threads which engage with internally-directed threads inside the body 411 to hold the cylinder 413 in place within the body 411.

The cylinder 413 bounds and defines a cylindrical interior 420 of the tool 410 in which a piston 421 reciprocates between an advanced position toward the front end of the cylinder 413 and a retracted position toward the rear end of the cylinder 413. The interior 420 is substantially enclosed; the body 411 encloses the rear end of the interior 420 and the cylinder 413 encircles the interior 420. The cylinder 413 terminates forwardly with an open neck 422, but a quick-connect coupling mount 414 is fit onto the end of that neck 422.

Below the body 411, and formed integrally and monolithically as part of the same sidewall forming the body 411, the handle 412 extends downward and provides a location at which a worker can grab and hold the tool 410. The handle 412 is a slender extension of the body 411. It is, like the body 411 to which it is formed, constructed from a hard, rigid, rugged, and durable material or combination of materials, such as high-density plastic or metal. The handle 412 extends from a top to an opposed bottom. A slot through the body 411 is formed at the top, and the trigger is disposed in this slot. The handle 412 is generally thin between the top and the bottom, and flares outwardly at the bottom. An end cap 430 is affixed to the bottom, where a pneumatic coupling 431 is located and available to receive a pneumatic hose 432. In some embodiments, a pneumatic adjuster is proximate the end cap 430 and adjustable to set the flow rate of gas through the end cap 430. In other embodiments, that adjuster is separate from the end cap 430 as a dedicated control.

Preferably, as shown in these drawings, most of the length of the handle 412 is covered by an anti-shock cushioned grip 433. The grip 433 is a sleeve fit over the handle 412 to provide the worker with cushion when operating the tool 410 to reduce transmission of vibration and impact forces from the tool 410 to the worker.

The trigger is disposed in the slot in front of the handle 412 to be depressed by an index finger of the worker. Depression of the trigger causes the tool 410 to operate. When the trigger is depressed, compressed gas, preferably supplied by a pneumatic hose 432 connected to the pneumatic coupling 431 and extending from a compressor or other source, is routed into the componentry within the body 411.

The compressed gas passes into the interior 420 behind the piston 421 carried therein. The piston 421 is mounted for reciprocal movement within the cylinder 413. A port at the back of the cylinder 413 communicates the supplied compressed gas into the interior 420 behind the piston 421, and the piston 421 quickly moves forward as the interior 420 behind the piston 421 fills with gas. As the piston 421 moves forward, that gas is vented, and then a port at the front end of the cylinder 413 communicates supplied compressed gas in front of the piston 421.

This causes the piston 421 to move quickly backward as the interior 420 in front of the piston 421 fills with gas. Gas is rapidly cycled between these two ports, causing the piston 421 to rapidly reciprocate between the advanced and retracted positions. The cylinder 413 has a larger bore than is typical of other pneumatic tools. Whereas conventional tools have a 0.750 inch bore, the bore of the cylinder 413 is preferably, but not necessarily, 0.814 inches. This larger bore provides greater energy per stroke length, resulting in more powerful and faster hammering. It should be understood that the bore dimension of 0.814 inches, though preferable, is by no means intended to be limiting in this disclosure, and the cylinder 413 may have other dimensions while remaining operable and suitable for the function of the tool 410.

The interior 420 of the cylinder 413 includes an interior bevel surface 423. The bevel surface 423 is a confrontation surface for the piston 421. The bevel surface 423 extends from the larger inner diameter of the cylinder 413 to the smaller inner diameter of the neck 422 at the front end of the cylinder 413. The bevel surface 423 is oriented roughly at a forty-five degree angle with respect to the inner surfaces of both the cylinder 413 and the neck 422. Just downstream of the bevel surface 423 is an annular notch 424 extending into the sidewall of the cylinder 413 and the neck 422. The notch 424 is an annular hollow space and preferably remains empty during operation of the tool 410. The neck 422 extends forwardly from the cylinder 413 proximate the notch 424. The neck 422 has a smooth inner surface and a threaded outer surface. The neck 422 terminates at an opening or mouth 425 at the front end of the cylinder 413. A flat, planar, annular confrontation surface 426 bounds the mouth 425. A small bevel is formed at the inner end of the confrontation surface 426 around the mouth 425.

The quick-connect coupling mount 414 (hereinafter, the “mount 414”) is an interface with the body 411 and an engagement secured on the cylinder 413. The mount 414 includes a threaded collar 440, an annular retaining ring 441, an outer collar 442, an outer sleeve 480 fit over part of the outer collar 442, and other parts.

The threaded collar 440 has opposed front and rear ends and opposed inner and outer surfaces. The outer surface of the threaded collar 440 is smooth. The inner surface of the threaded collar 440 includes threads 443. The threads 443 on the inner surface are complemental to the threaded outer surface of the neck 422. When applied to the neck 422, the threaded collar 440 threadably engages with the neck 422, and the rear end of the threaded collar 440 captures the retaining ring 441 against an outer surface of the cylinder 413.

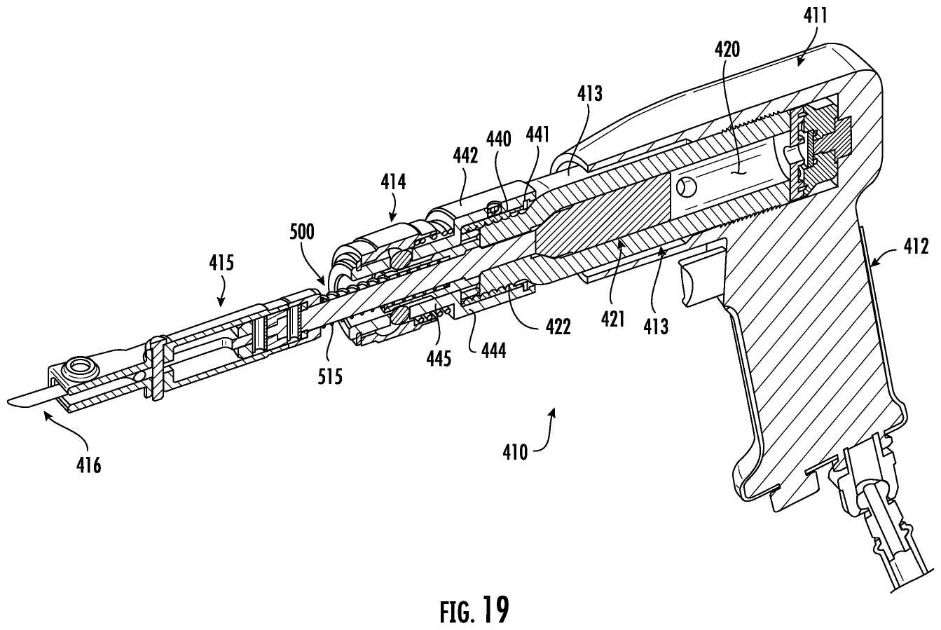

As shown in FIGS. 18 and 19, the annular retaining ring 441 is fit over the front end of the cylinder 413, where the cylinder 413 transitions into the neck 422. The threaded collar 440, when fully threadably engaged on the neck 422, compresses the retaining ring 441 against the cylinder 413. The outer diameter of the retaining ring 441 is greater than the outer diameter of the threaded collar 440, such that the retaining ring 441 projects radially outward beyond the outer surface of the threaded collar 440. This upstanding projection defines a lip.

The outer collar 442 is anchored on that lip. The outer collar 442 has two sections forming an integral whole. The outer collar 442 includes a rear collar 444 formed integrally to an inner barrel 445. The larger-diameter rear collar 444 fits over the neck 422 of the cylinder 413, and the reduced-diameter inner barrel 445 projects axially in front of that collar 444.

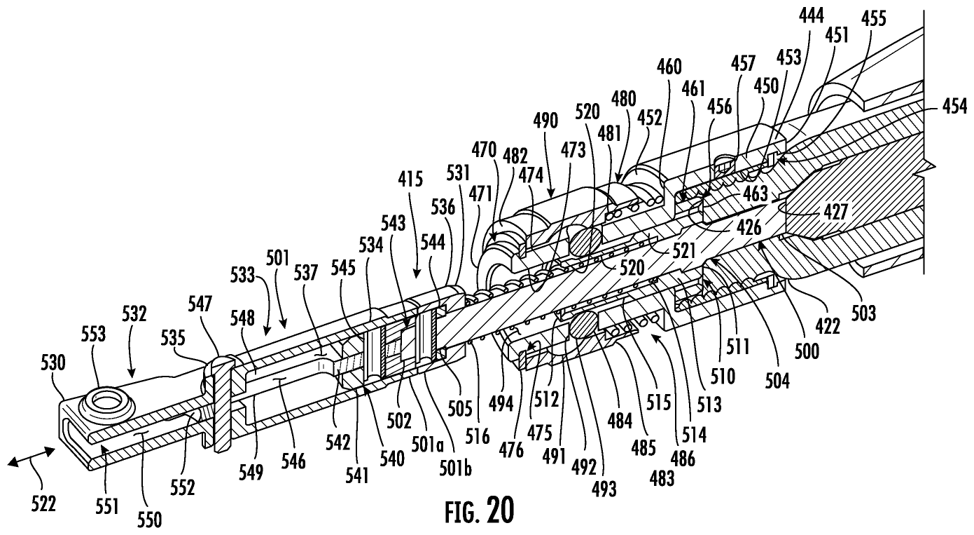

Referring now primarily to FIG. 20, the rear collar 444 has a generally cylindrical sidewall 450 having a rear end 451 and an opposed front end 452. The rear collar 444 has an inner surface 453 which is generally smooth between the front and rear ends 452 and 451 except at the rear end 451. At the rear end 451, there is an annular channel 454 extending radially inward into the sidewall 450. The channel 454 is spaced just slightly in front of the rear end 451 and thus defines a lip 455 projecting radially inward.

When the rear collar 444 is on the tool 410, the inner surface 453 of the rear collar 444 is fit in direct contact with the outer surface of the threaded collar 440. The lip 455 of the rear collar 444 fits over the retaining ring 441 projecting radially outward from beyond the outer surface of the threaded collar 440; the retaining ring 441 is received in the annular channel 454. The front end of the threaded collar 440 is in axial and radial confrontation with the front end 452 of the rear collar 444.

The threaded collar 440 is threadably engaged to the neck 422 of the tool 410. The threaded collar 440 binds the retaining ring 441 and holds it securely in place. The rear collar 444 of the mount 414 fits over both the threaded collar 440 and the retaining ring 441, and the threaded collar 440 and retaining ring 441 limit axial reciprocal movement of the rear collar 444 with respect to the body 411.

A set screw 457 is also inserted into a bore in the sidewall 450 and threaded down against the outer surface of the threader collar 440, further preventing relative movement. In embodiments, there may be one, none, or several set screws 457. The set screw 457 limits not only axial reciprocal movement but also rotational movement of the rear collar 444 with respect to the threaded collar 444. Because the rear collar 444 is an integral part of the mount 414, the mount 414 is limited in axial reciprocal movement and rotational movement with respect to the body 411.

Further limiting relative movement of the rear collar 444 is a washer 456 disposed between the rear collar 444 and the confrontation surface 426 of the neck 422. In some embodiments, the washer 456 is a rigid and hard piece of material, while in other embodiments, such as shown in FIG. 20, the washer 456 has compressive or elastomeric material characteristics.

The washer 456 is disposed in an annular space between the confrontation surface 426 and the mount 414. The front end 452 of the rear collar 444 terminates and turns radially inwardly at a flange 460. The flange 460 joins the rear collar 444 and the inner barrel 445 as an integral unit. The flange 460 has an inner surface directed rearwardly, toward the confrontation surface 426 of the neck 422. Between that inner surface and the confrontation surface 426, and inboard of the threaded collar 440, is an annular cavity 461. The washer 456 is kept in this annular cavity 461.

The washer 456 has an annular body and a large central bore, coaxial to the neck 422. The washer 456 includes a front end 462 and an opposed rear end 463. The front end 462 of the washer 456 is in confrontation against the inner surface of the flange 460, and the rear end 463 of the washer 456 is in confrontation against the confrontation surface 426 of the neck 422. The washer 456 is thus trapped axially between the mount 414 and the neck 422. In embodiments in which the washer 456 is compressive or elastomeric, the washer 456 preferably is oversized for the annular cavity 461 and is axially compressed between the mount 414 and the neck 422. The washer helps bias the mount 414 forwardly, which further helps engage the rear collar 444 with the threader collar 440 and the retaining ring 441.

From the inner end of the flange 460, the inner barrel 445 projects forwardly. The inner barrel 445 has a generally cylindrical sidewall 470 extending between a front end 471 and a rear end 472, formed to the flange 460. The inner barrel 445 has an inner surface 473 and an opposed outer surface 474. The inner surface 473 is contiguous to the inner surface 453 of the rear collar 444, and the outer surface 474 is contiguous to the outer surface of the rear collar 444 as well. The inner surface 453 is smooth and cylindrical. The outer surface 474 is also smooth but for an annular channel 475 formed inwardly from the outer surface 474 proximate the front end 471. A retaining ring 476 is received in the annular channel 475 and held there. The retaining ring 476 defines a forward stop for the outer sleeve 480, which slides over the inner barrel 445.

Referring still to FIG. 20, the outer sleeve 480 is a sliding, locking sleeve for securing an attachment 415 within the mount 414. The inner barrel 445 carries the outer sleeve 480. The outer sleeve 480 moves or slides axially relative to the inner barrel 445 between advanced and retracted positions to arrange the mount 414 in either locked or unlocked conditions, respectively. The sleeve 480 is biased into the locked condition by a helical compression spring 481 disposed behind the sleeve 480 and radially between the inner barrel 445 and outer sleeve 480. The spring 481 biases the outer sleeve 480 forwardly.

The outer sleeve 480 includes a front end 482 and a rear end 483, and an inner surface 484 and outer surface 485. In the embodiment shown in FIG. 20, the outer surface 485 is preferably knurled so that it may be easily gripped to move the outer sleeve 480. The inner surface 484 has a few features. Proximate the front end 482, the inner surface 484 is smooth, allowing it to slide along the outer surface 474 of the outer barrel 445. There, it defines a narrow diameter. Proximate the rear end 483, the inner surface 484 is radially outboard, defining a larger diameter than proximate the front end 482. Because it is set back, the inner surface 484 defines an annular retaining space 486. The retaining space 486 captures the helical compression spring 481. The spring 481 is bound at its front end by the retaining space 486 and on its rear end by the flange 460 between the rear collar 444 and the inner barrel 445.

The inner barrel 445 and the outer sleeve 480 form part of an engagement assembly 490 for locking the attachment 415 to the tool 410. Proximate to the front end 482 of the outer sleeve 480, on the inner surface 484 thereof, partially-spherical depressions 491 extend into the body of the outer sleeve 480 from the inner surface 484 and are circumferentially set apart. Opposing these depressions 491, a set of circumferentially spaced-apart holes 492 are formed in and through the sidewall 470 of the inner barrel 445. Ball bearings 493 are carried in the holes 492 in the inner barrel 445 and are moved radially either into or out of these depressions 491 when the outer sleeve 480 is moved forward and backward. Engagement and disengagement of the ball bearings 493 locks and unlocks the mount 414.

FIG. 20 shows the mount 414 in the locked condition. The outer sleeve 480 is slid forward and is prevented from further forward movement by confrontation with the retaining ring 476 at the front end 471 of the outer barrel 445. As such, the depressions 491 are axially offset from the holes 492, so that the ball bearings 493 cannot move from the holes 492 into the depressions 491. Rather, the ball bearings 493 are retained in the holes 492 in the inner barrel 445. Indeed, in this locked condition of the mount 414, the inner surface 484 of the outer sleeve 480 pushes or urges the ball bearings 493 into the holes 492 and toward a central interior space 494 within the inner barrel 445.

When an attachment 415 is in the mount 414, as in FIG. 20, the ball bearings 493 are pushed into the attachment 415. When the outer sleeve 480 is in the advanced position thereof, the ball bearings 493 define a circle within the central interior space 494 having an inner diameter. That inner diameter is smaller than an outer diameter of the attachment 415, so that the attachment 415 cannot be removed from the mount 414. The mount 414 can be unlocked, however, which draws the ball bearings 493 back to define a different, larger inner diameter that is larger than the attachment 415 and does allow the attachment 415 to be removed from the mount 414.

FIG. 20 shows an exemplary attachment 415. The attachment 415 includes a long shank 500 and a head sleeve 501 fit onto the end of the shank 500 for holding a staple. The shank 500 has a front end 502, an opposed rear end 503, and a length extending therebetween. The shank 500 has an outer diameter which is generally constant along its length but does vary in some places. Proximate the rear end 503, the shank 500 has a first diameter. Inboard of the rear end 503, the shank 500 has an enlarged diameter at an expansion 504. Forward of the expansion 504, the diameter of the shank 500 reduces back to the first diameter. The shank 500 continues forwardly along its length. Proximate the front end 502, the diameter of the shank 500 reduces again at a tip 505.

A base sleeve 510 is fit onto the shank 500 to allow it to couple with the mount 414. The base sleeve 510 is a cylindrical sleeve or tube, having a rear end 511 and an opposed front end 512. The rear end 511 of the base sleeve 510 encircles the expansion 504 and thus has an inner diameter corresponding to the diameter of the shank 500 at the expansion 504. Forward of the rear end 511, the inner surface of the base sleeve 510 contracts inwardly at a taper 513, following the profile of the shank 500 in front of the expansion 504. In this way, the base sleeve 510 is fit snugly onto the shank 500 and is prevented from moving axially backward on the shank 500.

In front of this taper 513, the inner surface of the base sleeve 510 is recessed back, defining an annular cavity 514 that extends entirely from the taper 513 to the front end 512 of the base sleeve 510. The annular cavity 514 captures the rear end of a helical compression spring 516.

The outer surface of the base sleeve 510 has a profile. Inboard of the front end 512, the base sleeve 510 has a depression 515 that extends into the base sleeve 510 along approximately the forward one-third to one-half of the length of the base sleeve 510. The depression 515 wraps entirely around the circumference of the base sleeve 510. The ball bearings 493 slide in this depression 515. The depression 515 is set in from the front end 512, defining a lip 520 at the front end 512 which projects radially outward in front of the depression 515 and a base 521 which projects radially outward behind the depression 515.

The attachment 415 also includes the head sleeve 501 (also referred to herein as just the “head 501”) mounted on the front of the shank 500. The head sleeve 501, as shown in FIG. 20, has a front end 530 and an opposed rear end 531. The head sleeve 501 includes a nozzle 532 proximate to the front end 530 and a stroke cylinder 533 behind the nozzle 532. The shank 500 extends into the stroke cylinder 533 to drive a staple held in the nozzle 532 out of the tool 410 and into a workpiece. In some embodiments, as shown in FIG. 20, the head sleeve 501 includes two separate parts secured, bonded, or otherwise fixed together, such as a forward sleeve 501a and a sleeve cap 501b. In other embodiments, the head sleeve 501 is a single, monolithic structure, and the forward sleeve 501a and sleeve cap 501b are monolithically formed to each other.

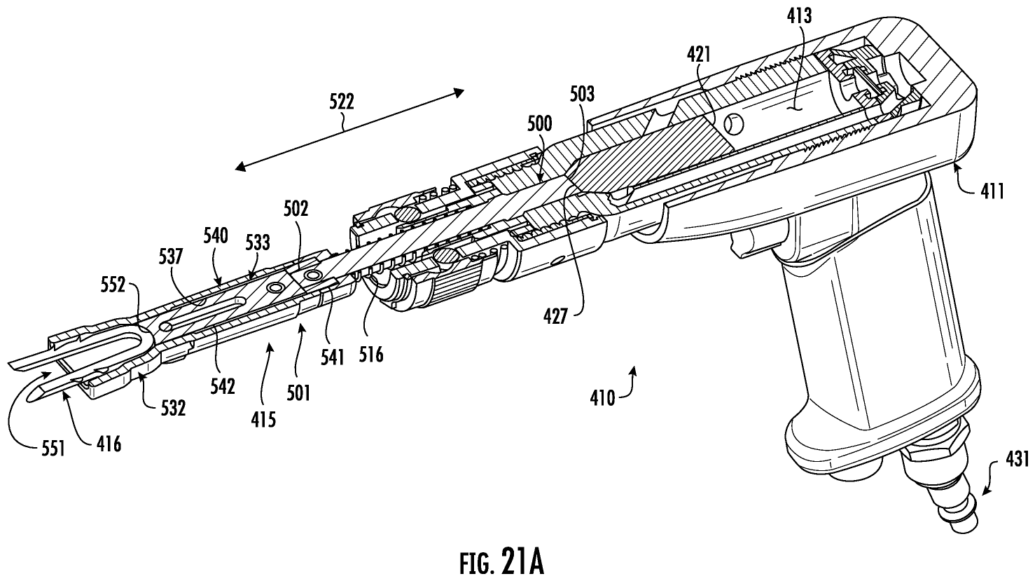

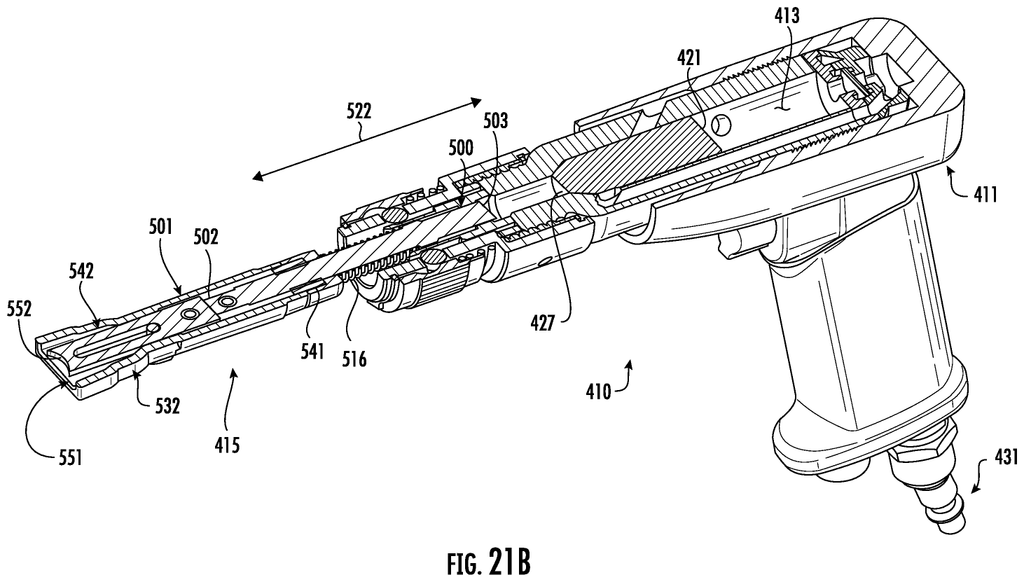

The stroke cylinder 533 has a generally cylindrical sidewall 534 with a front end 535 formed in communication with the nozzle 532 and an opposed open rear end 536 at the rear end 531 of the head 501. The sidewall 534 bounds an internal hold 537. The hold 537 is open at opposed ends. Carried in the hold 537 is a two-piece rod 540. The rod 540 is formed of a block 541 and an interlocked tongue 542 projecting forward from the block 541. As shown in FIGS. 21A and 21B, the rod 540 is carried in the hold 537 for reciprocal movement between an advanced position (FIG. 21B) and a retracted position (FIG. 21A) along an axial direction, indicated by the double-arrowed line 522 in FIGS. 21A and 21B, in response to reciprocation of the shank 500 with respect to the sleeve 501.

The block 541 is cylindrical and fits closely within the stroke cylinder 533. The internal surface of the stroke cylinder 533 defines a cross-sectional area, preferably circular, which is normal to the axial direction. The block 541 occupies that cross-sectional area. In other words, the block 541 is close fit to the internal surface of the stroke cylinder 533, with no gaps between the block 541 and the stroke cylinder 533. The block 541 also occupies an axial portion of the hold 537, taking up approximately one-half of the volume of the internal hold 537. The block 541 has an open socket 543.

The open socket 543 has a large diameter extending toward the rear end of the block. The front end 502 of the shank 500 is fit and secured into this portion of the open socket 543. The front end 502 of the shank 500 is snugly received in the socket 543. A pin 544 extends through a bore in the block 541 and through a bore in the shank 500, binding the block 541 and shank 500 together. Both the block 541 and the front end 502 of the shank 500 are thus carried within the stroke cylinder 533 for reciprocal movement forward and backward along the axial direction indicated by the double-arrowed line 522 in FIG. 21A.

The stroke cylinder 533 moves with respect to the shank 500, or, from another perspective, the shank 500 moves with respect to the stroke cylinder 533. The compression spring 516 is compressed between the annular cavity 514 at the rear end of the spring 516 and the rear end 531 of the head 501 at the front end of the spring 516, and as the block 541 moves within the stroke cylinder 533, the head 501 moves on the shank 500, and the spring 516 compresses and extends.

The tongue 542 projects forwardly from the block 541. The tongue 542 is engaged with the block 541. The open socket 543 of the block 541 has a small diameter extending toward the front end of the block 541. The rear end of the tongue 542 is fit and secured into this portion of the open socket 543. A pin 545 extends through a bore in the block 541 and through a bore in the tongue 542, binding the block 541 and tongue 542.

Both the shank 500 and the tongue 542 are secured in the open socket 543 of the block 541. The front end of the shank 500 and the rear end of the tongue 542 are in confronting or abutting direct contact with each other when secured in the block 541.

The tongue 542 is a flat bar extending in a single horizontal plane, defined by the width of the flat bar tongue 542. That plane is not shown in the drawings, but the reader will clearly understand that the plane is coplanar to the median of the tongue 542, extending laterally outward along the axial direction 522 and normal thereto. The tongue 542 has opposed sides which are close fit against the inner surface of the internal hold 537. The tongue 542 also has opposed flat faces. One face (shown upwardly in FIG. 20) defines a void 548 between it and the inner surface of the internal hold 537. The other face defines a void 549 between it and the inner surface of the internal hold 537.

The two voids 548 and 549 are preferably mirror identical, opposed from each other on opposite faces of the tongue 542. They are roughly semi-cylindrical. The opposing voids 548 and 549 flank opposing faces of the tongue 542. The tongue 542 and voids 548, 549 fill the cross-sectional area of the internal hold 537.

The tongue 542 also has an elongate, central cutout 546 extending entirely between the two opposed faces. This cutout 546 is in communication with the voids 548 and 549, joins the voids 548 and 549 in communication, and fits around a post 547 at the front end 530 of the head 501 during reciprocation of the tongue 542. The post 547 is mounted entirely through the head 501 from one side of the sidewall 534 to the opposing side of the sidewall 534, and the post 547 is disposed in and extends through a slot 550 in the nozzle 532. As the block 541 slides reciprocally within the stroke cylinder 533, the tongue 542 also reciprocates in the stroke cylinder 533 and in the nozzle 532, and the cutout 546 reciprocates backward and forward over the post 547.

The front end of the tongue 542 projects into the nozzle 532. The nozzle 532 includes the wide slot 550 terminating in a wide, thin muzzle 551 at the front end 530 of the head 501. The slot 550 is formed in communication with the stroke cylinder 533. The slot 550 is roughly three to four times wider than it is tall. The front end of the tongue 542 is formed with a concave surface 552 sized and shaped to receive a variety of staple designs. The tongue 542 lies in a horizontal plane, and the plane is registered with the slot 550. The front end of the tongue 542 terminates inside the slot 550, just behind the muzzle 551. As shown in FIG. 20, a magnet 553 is set into the top of the nozzle 532, forward of the front end of the tongue 542 even the rod 540 is in its advanced position. When a staple is loaded in through the muzzle 551, the magnet 553 holds the staple in place in the slot 550 and the tongue 542 strokes forward to impact the staple from behind and push it into the workpiece.

Referring now to FIG. 17, in operation, the tool 410 is useful for driving staples of different sizes, shapes, and configurations into a workpiece. FIG. 21A illustrates the tool 410 with a staple 416 carried in the nozzle 532. To operate the tool 410, the worker couples a hose to the pneumatic coupling 431, and compressed or pressurized air or gas is supplied to the tool 410.

The worker grasps the tool 410 by hand and ensures a stapler 416 is in the nozzle 532. If there is no staple 416 present, the worker inserts a free staple, crown-first, through the muzzle 551 until the crown touches the concave surface 552 at the front end of the tongue 542. The magnet 553 in the nozzle 532 holds the staple 416 in place. The stapler 416 is now ready.

The worker presses the muzzle 551 of the attachment 415 against the workpiece and may slightly depress the head 501 on the shank 500. The worker presses the tool 410 with sufficient force to ensure that the tool 410 is securely held with respect to the workpiece.

When the worker depresses the trigger, the compressed gas passes into the cylinder 413 behind the piston 421, causing the piston 421 to cycle within the cylinder 413. The piston 421 slams forward, and a striking surface 427 at its front end impacts or rams into the rear end 503 of the shank 500. The shank 500 moves forward.

Because the head 501 is pressed against the workpiece, the head 501 does not move forward with the shank 500. Rather, the shank 500 moves with respect to the head 501. While the head 501 remains stationary, the front end 502 of the shank 500 reciprocates within the internal hold 537. The front end 502 of the shank 500 drives forward within the stroke cylinder 533, causing the two-piece rod 540 of the block 541 and tongue 542 to drive forward as well. The concave surface 552 of the tongue 542 is in direct confrontation with the staple 416, and so the tongue 542 pushes the staple 416 out of the nozzle 532 with great speed and force, into the workpiece.

After the staple 416 is fired, the tool 410 cycles. The piston 421 slides back, and the compression spring 516 biases the head 501 and the shank 500 apart. The tool 410 is ready for loading with a fresh staple.

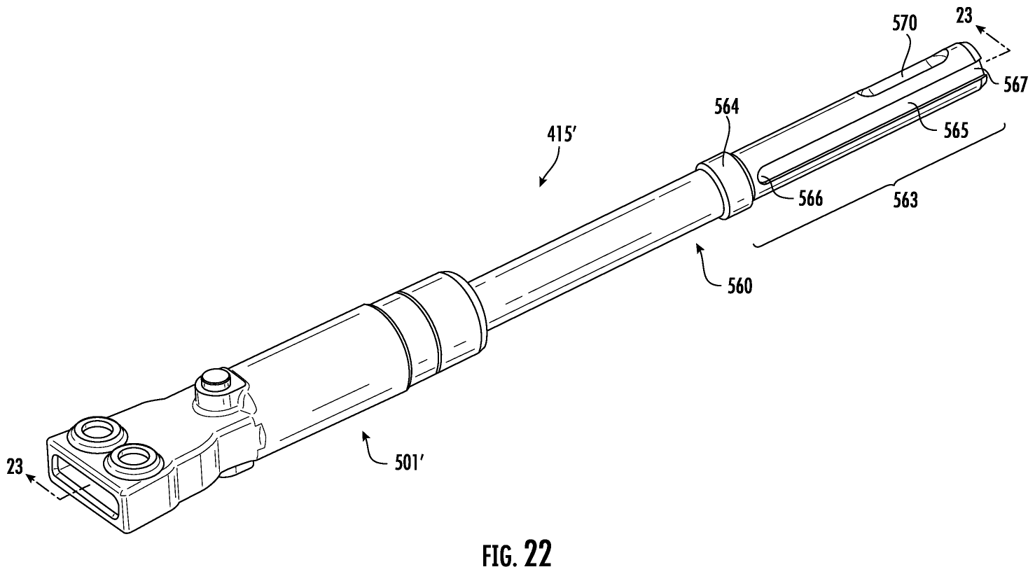

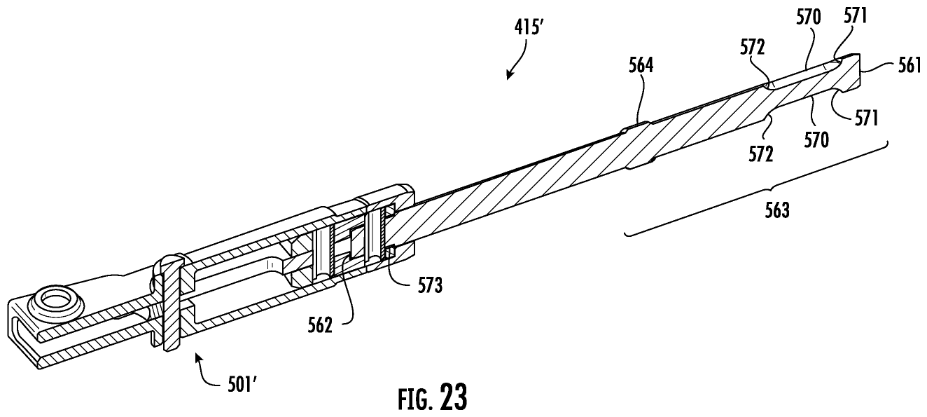

FIGS. 22 and 23 show an alternate embodiment of the attachment 415. These two drawings use the reference character 415′ to designate this alternate embodiment. The attachment 415′ is similar to the attachment 415 in all respects except as noted herein. To that end, except as otherwise noted, all structural features and elements of the attachment 415′ are identical to the structural elements and features of the attachment 415 where the reference characters are the same, though the reference characters associated with the elements and features of the attachment 415 are marked with a prime symbol (“′”) to distinguish them from those of the attachment 415.

The attachment 415′ includes a long shank 560 and a head 501′ fit onto the end of the shank 560 for holding a staple. The head 501′ is identical to the head 501 described above and includes all the same structural elements and features thereof. As such, those structural elements and features are not described herein, and the reader will understand that those elements and features are the same.

The shank 560 is a long, cylindrical, constant-diameter shank extending from a rear end 561 to an opposed front end 562 (only FIG. 23 shows both ends 561 and 562). Across most of the length of the shank 560 between the ends 561 and 562, the shank 560 has a constant diameter, except in a few locations described below.

The shank 560 includes an engagement portion 563 extending forwardly from the rear end 561 to a flange 564 generally intermediate along the length of the shank 560. Between the rear end 561 and the flange 564, the engagement portion 563 includes two oppositely-positioned open channels 565. Only one open channel 565 can be seen in FIG. 22, but an identical open channel 565 is located in a diametrically opposed position on the other side of the shank 560.

The open channel 565 is a groove or depression extending axially along the length of the shank 560. The open channel 565 has a rear end coextensive with the rear end 561 of the shank 560 and has an opposed front end 566 just behind the flange 564. The open channel 565 is a straight slot in communication with the rear end 561, and the front end 566 is closed and curved. The rear end of the open channel 565 forms a notch 567 at the rear end 561 of the shank 560. The notch 567 is an entrance to the open channel 565.

Between the rear end 561 and the flange 564, the engagement portion 563 also includes two oppositely-positioned closed channels 570. While only one closed channel 570 can be seen in FIG. 22, both closed channels are seen in the section view of FIG. 23. Each closed channel 570 is a groove or depression extending axially along the length of the shank 560. The closed channel 570 is a straight slot and has a rear end 571 and an opposed front end 572. Both the rear and front ends 571 and 572 are closed and curved.

The closed channels 570 are disposed in spaced relation in front of the rear end 561 of the shank 560. The closed channels 570 are also circumferentially spaced apart from the open channels 565. In other words, moving in a circumferential direction around the shank 560, one encounters a first of the closed channels 570, then a first of the open channels 565, then a second of the closed channels 570, and then a second of the open channels 565. Each channel 565, 570 is spaced apart roughly by one-quarter of the circumference of the shank 560 from its adjacent channels 565, 570.

The shank 560 extends from the flange 564 to the front end 562. Just behind the front end 562, the diameter of the shank reduces, forming a tip 573. The tip 573 is identical in diameter and length to the tip 505 described above. The tip 573 extends forwardly to the front end 562 a short distance.

The attachment 415′ includes the head 501′. The head 501′ is identical to the head 501 described above. Indeed, the head 501 described above with respect to the attachment 415 is the same head 501′ used with the shank 560 to form the attachment 415′, but it is marked with a prime symbol here to distinguish it from the head 501 of other embodiments. However, the head 501′ has all the same structural elements and features of the head 501, and the above description of those structural elements and features of the head 501 need not be repeated here, as the reader will understand that description is equally applicable here.

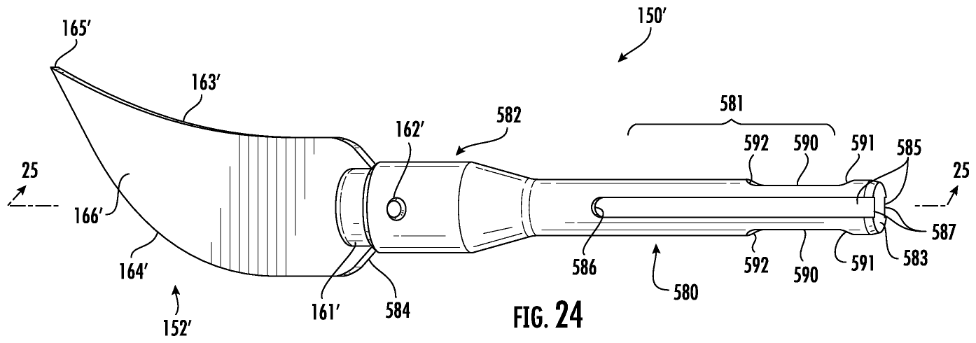

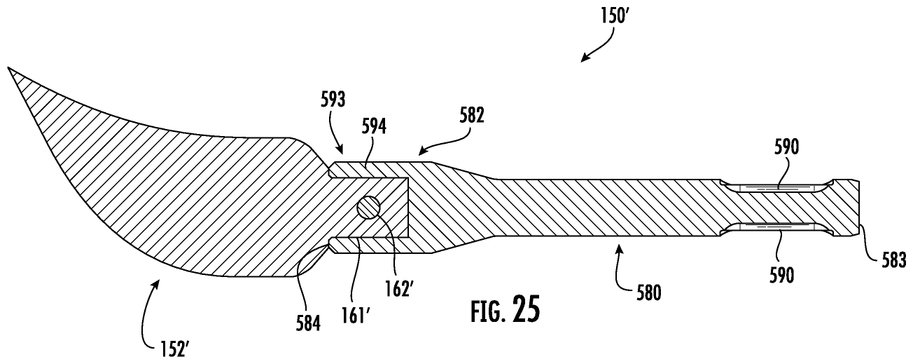

FIGS. 24 and 25 show an alternate embodiment of the remover 150. These two drawings use the reference character 150′ to designate this alternate embodiment. The attachment 150′ is similar to the remover 150 in all respects except as noted herein. To that end, except as otherwise noted, all structural features and elements of the attachment 150′ are identical to the structural elements and features of the remover 150 where the reference characters are the same, though the reference characters associated with the elements and features of the remover 150 are marked with a prime symbol (“′”) to distinguish them from those of the remover 150.

The attachment 150′ includes a shank 580 and a blade 152′ fit onto the end of the shank 580 for slipping under, prying loose, and removing staples. The blade 152′ is identical to the head 501 described above and includes all the same structural elements and features thereof. As such, those structural elements and features are not described herein, and the reader will understand that those elements and features are the same.

The shank 580 is an elongate cylinder. It includes an engagement portion 581 at a rear end 583 and a chuck 582 in front of the engagement portion 581 at a front end 584. The engagement portion 581 extends forwardly from the rear end 583 to the chuck 582 and includes two oppositely-positioned open channels 585. The entirety of only one open channel 585 can be seen in FIG. 24, but an identical open channel 585 is located in a diametrically opposed position on the other side of the shank 580.

The open channel 585 is a depression extending axially along the length of the shank 580. The open channel 585 has a rear end coextensive with the rear end 583 of the shank 580 and has an opposed front end 586 just behind the chuck 582. The open channel 585 is a straight slot in communication with the rear end 583, and the front end 586 is closed and curved. The rear end of the open channel 585 forms a notch 587 at the rear end 583 of the shank 580. The notch 587 is an entrance to the open channel 585, and the notches 587 of both open channels 585 are visible in FIG. 24.

Between the rear end 583 and the chuck 582, the engagement portion 581 also includes two oppositely-positioned closed channels 590. Both closed channels 590 are visible in the FIG. 24 and in the section view of FIG. 25. Each closed channel 590 is a depression extending axially along the length of the shank 580. The closed channel 590 is a straight slot and has a rear end 591 and an opposed front end 592. Both the rear and front ends 591 and 592 are closed and curved.

The closed channels 590 are disposed in spaced relation in front of the rear end 583 of the shank 580. The closed channels 590 are also circumferentially spaced apart from the open channels 585. In other words, moving in a circumferential direction around the shank 580, one encounters a first of the closed channels 590, then a first of the open channels 585, then a second of the closed channels 590, and then a second of the open channels 585. Each channel 585, 590 is spaced apart roughly by one-quarter of the circumference of the shank 580 from its adjacent channels 585, 590.

The shank 580 extends from the chuck 582 to the front end 584. Just behind the front end 584, the diameter of the shank tapers outwardly and enlarges, forming the chuck 582. As shown in the section view of FIG. 25, the chuck 582 includes an internal socket 593, recess, or depression extending into the shank 580 from the front end 584. This defines in the chuck 582 an outer sleeve 594 which is integrally and monolithically formed as part of the shank 580, but which is hollow. A cylindrical base 161′ of the blade 152 is fit into the socket 593, and a pin 162′ through the sleeve 594 of the socket 593 secures the base 161′ in the socket 593.

The attachment 150′ includes the blade 152′. The blade 152′ is identical to the blade 152 described above with respect to the remover 150. Indeed, the blade 152 described above is the same blade 152 used with the shank 580 to form the attachment 150′, but it is marked with a prime symbol here to distinguish it from the blade 152 of other embodiments. However, the blade 152′ has all the same structural elements and features of the blade 152, and the above description of those structural elements and features of the blade 152 need not be repeated here, as the reader will understand that description is equally applicable to this blade 152′. For that reason, the structural elements and features of the blade 152′ adopt the same reference characters of the blade 152 but are marked with a prime symbol, such as the base 161′ and the pin 162′.

A preferred embodiment is fully and clearly described above so as to enable one having skill in the art to understand, make, and use the same. Those skilled in the art will recognize that modifications may be made to the description above without departing from the spirit of the specification, and that some embodiments include only those elements and features described, or a subset thereof. To the extent that modifications do not depart from the spirit of the specification, they are intended to be included within the scope thereof.

What is claimed is:

1. An attachment for a powered tool comprising:
a shank having a front end, a rear end, and a length extending therebetween;
a head sleeve fit over the shank proximate the front end thereof and extending beyond the front end, the head sleeve including a front end, an opposed rear end, and a nozzle at the front end of the head sleeve having a slot terminating at a muzzle;
an internal hold in the head sleeve, the internal hold in open communication with the slot in the nozzle;
the front end of the shank is disposed within the internal hold of the head sleeve and reciprocates therein along an axial direction;
a rod carried within the head sleeve for reciprocal movement between advanced and retracted positions in response to reciprocation of the front end of the shank with respect to the head sleeve, wherein the rod includes a block carried in the internal hold and a tongue extending from the internal hold into the slot of the nozzle; and
the tongue terminates inside the slot for reciprocal movement within the slot in response to reciprocal movement of the shank with respect to the head sleeve.

2. The attachment of claim 1, wherein the tongue reciprocates over a post in the head sleeve.

3. The attachment of claim 2, wherein the post is disposed in the slot.

4. The attachment of claim 2, wherein the tongue includes a cutout for receiving the post as the tongue reciprocates over the post.

5. The attachment of claim 1, wherein:
the block is close fit within a cross-sectional area defined by the internal hold, wherein the cross-sectional area is normal to the axial direction; and
the tongue is carried in the internal hold such that there are opposing voids flanking opposing faces of the tongue inside the internal hold.

6. The attachment of claim 1, wherein:
the tongue extends forward from the block in a horizontal plane, defining voids on opposing faces of the tongue inside the internal hold; and
the horizontal plane is registered with the slot in the nozzle.

7. The attachment of claim 1, wherein the block includes a socket which receives the front end of the shank.

8. The attachment of claim 7, wherein a pin couples the block to the shank at the socket.

9. The attachment of claim 8, wherein another pin couples the tongue to the block.

10. The attachment of claim 9, wherein the tongue has a rear end which is in confrontation with the front end of the shank inside the block.

11. The attachment of claim 1, further comprising:
a base sleeve fit over the shank proximate the rear end thereof, the base sleeve configured to be received in a mount of the powered tool; and
a spring extending along the length of the shank between the base sleeve and the head sleeve.

12. The attachment of claim 1, further comprising:
oppositely-positioned open channels extending along the shank to the rear end thereof, defining grooves in the shank; and
oppositely-positioned closed channels extending along the shank;
wherein the open channels are longer than the closed channels.

13. An attachment for a powered tool comprising:
a shank;
a blade secured to the shank, the blade configured to remove staples from a workpiece; and
the blade includes an inner edge and an opposed outer edge, wherein the inner edge is concave and the outer edge is convex;
wherein the shank includes an engagement portion opposite the blade configured to engage with the powered tool.

14. The attachment of claim 13, wherein the inner and outer edges meet at a sharp tip.

15. The attachment of claim 14, the sharp tip overhangs the concave inner edge.

16. The attachment of claim 13, wherein the inner edge is shorter than the outer edge.

17. The attachment of claim 13, wherein the inner and outer edges are blunt.

18. The attachment of claim 13, wherein the engagement portion includes:
oppositely-positioned open channels extending along the shank to a rear end thereof, defining grooves in the shank; and
oppositely-positioned closed channels extending along the shank;
wherein the open channels are longer than the closed channels.

19. The attachment of claim 13, wherein the shank includes a socket opposite the engagement portion, and the blade is secured in the socket.

20. A powered tool comprising:
a body housing a cylinder extending outwardly from the body to an end;
an impact piston carried within the cylinder for axial reciprocating movement, the impact piston including a striking surface at a front end thereof; and
a mount connected over the end of the cylinder, the mount configured to receive and releasably secure an attachment, wherein the attachment comprises:
a shank having a front end and an opposed rear end configured for receipt in the mount;
a head sleeve fit over the shank proximate the front end thereof and extending beyond the front end, the head sleeve including a front end and a nozzle at the front end of the head sleeve having a slot terminating at a muzzle;
an internal hold in the head sleeve, the internal hold in open communication with the slot in the nozzle;
the front end of the shank is disposed within the internal hold of the head sleeve and reciprocates therein along an axial direction; and
a rod carried within the head sleeve for reciprocal movement between advanced and retracted positions in response to reciprocation of the front end of the shank with respect to the head sleeve;
wherein the rod includes a tongue extending from the internal hold into the slot of the nozzle, and the tongue terminates inside the slot for reciprocal movement within the slot in response to reciprocal movement of the shank with respect to the head sleeve.
